(19) United States
(12) Patent Application Publication
(10) Pub. No.: US 2026/0310630 A1
(43) Pub. Date: Oct. 8, 2026

(54) GENERATING MULTIMODAL EXPERIENCES FROM SOURCE CONTENT

(71) Applicant: SINAI.AI, Inc., Wilmington, DE (US)

(72) Inventors: Mohamed ELSHENAWY, Cairo (EG); Ahmed Kamel Ahmed, Cairo (EG); Y. Eugene Shteyn, Cupertino, CA (US)

(21) Appl. No.: 19/462,162

(22) Filed: Jan. 28, 2026

Related U.S. Application Data
(60) Provisional application No. 63/750,675, filed on Jan. 28, 2025.

(51) Int. Cl. G06F 16/11; G06F 16/34; G06F 16/683; G06F 40/58

(52) U.S. Cl. CPC G06F 16/116; G06F 16/345; G06F 16/685; G06F 40/58

(57) ABSTRACT

Systems and methods that generate multimodal objects from content (e.g., text-based works, such as books) are described. In some examples, the systems and methods support and/or provide an ecosystem or platform for creating, validating, distributing, sharing, and/or using original or dynamically generated multimodal content and associated works.

### CROSS-REFERENCE TO RELATED APPLICATIONS

This application claims priority to U.S. Provisional Application No. 63/750,675, filed on Jan. 28, 2025, entitled GENERATING MULTIMODAL OBJECTS FROM CONTENT, which is hereby incorporated by reference in its entirety.

### BACKGROUND

We are seeing an evolving landscape of content creation and consumption, which pushes content providers and publishers to address the diverse needs of authors, content creators, publishers, and end-users while maintaining scalability, personalization, and compliance. Derivative works, such as content that expands upon or adapts original content pieces, can be beneficial by offering users deeper engagement and enabling publishers or providers to reach wider audiences with additional content. For example, while derivative works (e.g., translations, summaries, audiobooks, visual adaptations, interactive narratives, educational modules, and so on) are useful and readily consumed by users, typical methods for their creation suffer from various drawbacks. For example, the creation of derivative works, complementary and/or related content is often labor-intensive, inconsistent, costly, and utilizes significant time and resources without meeting the growing demand by users for dynamic and engaging content experiences.

### BRIEF DESCRIPTION OF THE DRAWINGS

FIG. 1 is a block diagram illustrating a suitable network environment that supports the platform/ecosystem.

FIG. 2 is a block diagram illustrating example modules of the content experience system.

FIG. 3 is a flow diagram illustrating an example transformation of source content to multimodal content experiences.

FIG. 4 is a block diagram illustrating example interactions between modules of the content experience system.

FIG. 5 is a block diagram illustrating example components of a multimodal content module.

FIG. 6 is a block diagram illustrating example components of an experience management module.

FIG. 7 is a flow diagram illustrating a method for providing multimodal content experiences to users.

FIG. 8 is a flow diagram illustrating a method for generating multimodal objects.

FIG. 9 is a diagram illustrating an example AI-ready content format for content.

FIGS. 10A-10F are diagrams illustrating example contents of a global content descriptor.

FIGS. 11A-11C are diagrams illustrating example metadata within a chunk descriptor for a content unit.

FIGS. 12A-12B are diagrams illustrating an example content section within a chunk descriptor for a content unit.

FIGS. 13A-13C are diagrams illustrating an example AI notes section within a chunk descriptor for a content unit.

FIG. 14 is a diagram illustrating an example setup of AI agents.

FIG. 15 is a diagram illustrating an example AI agent.

FIG. 16 is a flow diagram illustrating a workflow for converting source content into AI-ready formatted content.

FIG. 17 is a diagram illustrating an example user interface of an interactive book.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Systems and methods that generate multimodal objects from content (e.g., text-based works, such as books) are described. In some examples, the systems and methods support and/or provide an ecosystem or platform for creating, validating, distributing, sharing, and/or using original or dynamically generated multimodal content and associated works.

Typical formats of content can pose a significant challenge when leveraging artificial intelligence (AI) techniques during the creation and/or monetization of derivative works and associated content. For example, such formats may lack structures that explicitly represent relationships within a single piece of content (e.g., sections, paragraphs, or themes) and/or between different types of content (e.g., books, videos, audio, supplementary materials, and so on).

Currently, the formats prevent AI systems from establishing contextual or semantic connections across diverse content types and thus preventing the generation cohesive derivative works. For example, a format without clearly defined link may cause an AI system to not connect a concept introduced in a book to a visual explanation of the concept in a video, and/or the AI system may miss a thematic alignment between chapters of two different books. Such fragmentation can lead to inconsistent outputs and hamper the effective attribution, organization, and/or monetization of such AI generated content, among other drawbacks.

Further, certain derivative works or generated content (e.g., audiobooks, summaries) may not engage readers/users who may be seeking enhanced or new content experiences. For example, a user may seek content experiences that are interactive, such as experiences that respond to questions or other interactions, clarify complex concepts, and/or customize content to user preferences, comprehension levels, time constraints, and so on. For example, a reader may want to pause an audiobook to simplify the technical language, adjust the tone for a younger or less knowledgeable audience, and/or ask about the significance of a concept or passage. Such a growing demand for interactive experiences has introduced a significant gap in traditional content generation and delivery methods, limiting opportunities for deeper reader engagement based on current tools of content generation.

To bridge this gap, the systems and methods described herein integrate ML and AI models and algorithms (e.g., generative AI technologies) with robust content management frameworks. Such integration may transform existing workflows for creating, validating, licensing, distributing, and/or sharing original and derivative or generated works. For example, by automating or replacing traditionally labor-intensive processes, the systems and methods may accelerate the creation of new content experience, such as translations that maintain linguistic integrity, summaries tailored for diverse audiences, interactive elements that facilitate active engagement, and so on. Furthermore, the systems and methods, via the platform/ecosystem can enable real-time interaction (e.g., by interrupting a content presentation), to facilitate a user to ask questions, modify difficulty levels of the original content, or otherwise interact in a dynamic manner during their content experience.

For example, the systems and methods may receive a source document having a first format, convert the source document into a multimodal object having a second format, wherein the AI-ready content format includes a global content descriptor for the source document and multiple chunk descriptors for multiple sections of the source document, and provide access to the multimodal object for multiple AI agents configured to generate content experiences associated with the source document.

As another example, the systems and methods may receive a source document having a first format, convert the source document into a multimodal object having a format that includes a global content descriptor for the source document, multiple chunk descriptors for multiple sections of the source document, and fragment-level metadata, and provide access to the multimodal object for multiple AI agents configured to generate content experiences associated with the source document.

The systems and methods may utilize or leverage various types of machine learning (ML), including, but not limited to, generative AI to automate the transformation of original content into various types of works (e.g., different types of derivative works or multimodal objects), Example works include translations, audio narrations, summaries, visual adaptations, interactive question and answer (Q&A) sessions, course-style modules, and so on. The works may be enriched with metadata and structural guidelines to ensure compatibility across diverse content creation and distribution platforms, as well as various user applications.

In some examples, the ecosystem/platform integrates modular components, such as modules for content transformation, quality validation, licensing management, and/or interactive user engagement. A repository, located centrally or distributed across different locations, may store the original content and its associated works (e.g., derivatives), enabling efficient access for redistribution, personalization, and further uses or operations. The ecosystem/platform may also provide tools to authors and publishers for content creation and review, ensuring consistency and quality through automated workflows and/or human-in-the-loop mechanisms, among other benefits.

In some examples, the ecosystem/platform incorporates robust rights management capabilities, enabling the tracking, enforcement, and trading of content licenses across regions, usage scenarios, and formats. By integrating ML (e.g., generative AI or ML models) with advanced content management frameworks, the systems and methods offer a scalable and adaptive solution for delivering personalized multimodal content experiences (e.g., tailored and/or personalized to users).

Various examples of the systems and methods will now be described. The following description provides specific details for a thorough understanding and an enabling description of these examples. One skilled in the art will understand, however, that these examples may be practiced without many of these details. Additionally, some well-known structures or functions may not be shown or described in detail, to avoid unnecessarily obscuring the relevant description of the various examples. The terminology used in the description presented below is intended to be interpreted in its broadest reasonable manner, even though it is being used in conjunction with a detailed description of certain specific examples.

### Examples of a Suitable Network Environment

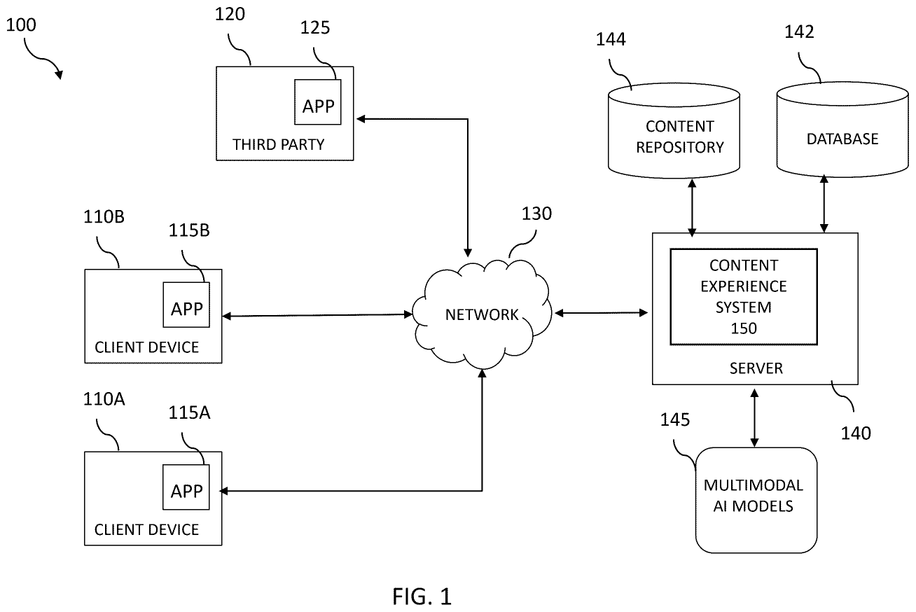

As described herein, the platform/ecosystem may be part of a network environment that is accessible to content authors and/or creators, third party providers, and various users multimodal content experiences. FIG. 1 is a block diagram illustrating a suitable network environment 100 that supports the platform/ecosystem.

A server 140 supports a content experience system 150, which may be considered a server system or other similar computing system that functions as a central processing hub and manages all interactions between client devices 110A-B and associated users, third-party entities 120, and other devices or entities. In some cases, the server 140 may operate as a single server instance or as a distributed system composed of multiple coordinated server nodes or services. The server 140 may handle communication with users, respond to inquiries or requests, and/or facilitates interactive experiences, publishing workflows, and/or content distribution. The context experience system 150, as described herein, may be part of or supported by a server application, which operates within the server infrastructure to ensure seamless execution of operations and/or functionalities by coordinating requests and responses across the platform.

In some examples, the content experience system 150 manages content generation through custom pipelines, which are responsible for processing, transforming, and generating various multimodal content experiences. The system 150 may incorporate and/or access a content repository 144 that stores generated experiences, such as audiobooks, summaries, and/or educational modules, ensuring efficient retrieval and delivery. In some cases, the content repository 144 is implemented using any suitable storage medium, including local storage, cloud-based storage services, distributed file systems, object storage platforms, and so on.

The content experience system 150 may interact with and/or support multimodal AI models 145, which form and/or operate as foundational models that power AI agents, enabling interactive experiences and the automatic generation of content. The multimodal AI models 145 may include one or more multimodal AI systems, such as external models, custom-developed models, or models adapted through post-training methods (e.g., fine-tuning, reinforcement learning, preference optimization, or other alignment mechanisms). The multimodal AI models 145 may be configured and/or employed to perform a wide range of tasks, including summarization, translation, and interactive Q&A.

The context experience system 150 may also support and/or access a database 142, which may represent any suitable data storage or persistence layer, including relational or non-relational databases, distributed data stores, object storage systems, vector databases, knowledge graphs, or other data management technologies. For example, the database 142, via a storage layer, can maintain critical or useful information, such as metadata, user profiles, licensing data, and interaction histories, ensuring compliance, accuracy, and alignment with user preferences.

The client devices 110A-B are primary interfaces through which users interact with the content experience system 150. The client devices 110A-B host client applications 115A-B that enable users to access and engage with content experiences that are generated, rendered, or otherwise provided by the system 150. The client devices 110A-B may be utilized by solo content consumers and/or and group content consumers, which request and consume personalized or collaborative content experiences.

Further, client devices 120, and associated client application 125, may facilitate third parties to access and interact with the system 150. For example, publisher, technology providers, or other entities may utilize the client application 125 to upload content, manage rights, or access AI-ready transformations and derivative content experiences. The client devices 120 may include any suitable computing platform or interface through which the third parties interact with the system 150, regardless of form factor or operating environment. Further, the client application 125 may be configured for content publishing, editing, management tasks, review workflows, validation steps, metadata enrichment, collaboration features, or other third-party operational processes.

The client devices 110A-B and 120 may include any suitable computing or interaction-capable hardware, such as smartphones, tablets, laptops, desktops, and immersive reality devices (e.g., AR/VR headsets, mixed reality systems, wearable displays, or other sensory or input-enabled hardware through which a user may interact with the system 150). Further, the client applications 115A-B and 125 may facilitate content retrieval, user interaction, device-specific rendering, and communication or synchronization with the system 150 and/or the server 140. Client applications 115A-B and 125 may also perform local processing, caching, or personalization tasks, and can integrate with device sensors or external services to support enhanced or context-aware interactions for associated uses or entities.

The client devices 110A-B and 120 communicate with the context experience system 150 via a network 130, such as the Internet. For example, the network 130 may serve as communication backbone, connecting the client devices 110A-B and 120 with the content experience system 150 via the server 140. The network 130 facilitates a seamless exchange of data when delivering personalized and multimodal content experiences. The network 130 can be implemented using various technologies, including the Internet, private networks, hybrid network configurations, or cloud-based communication systems, ensuring broad accessibility and reliability for users across different locations. The network 130 may also support distributed communication patterns, such as peer-to-peer, edge-assisted, or multi-region routing, depending on deployment requirements or preferences.

For example, solo content consumers and/or group content consumers, via the client devices 110A-B and the network 130, may send content requests, interact with AI-driven tools, and/or retrieve generated multimodal content experiences from the server 140. The system 150, via the network 140, may also support synchronous and asynchronous collaboration for group users, enabling features like AI moderation, shared annotations, and synchronized progress across client devices 110A-B. For third-party users, the network 130 may handle data transfers related to content uploads, publishing tasks, and rights management. In some cases, the network 130 may additionally support other operations, such as secure file exchange, metadata synchronization, and integration with external systems or services as requested by third-party workflows.

In some examples, the content experience system 150 may receive a source document having a first format, convert the source document into a multimodal object having a second format, wherein the AI-ready content format includes a global content descriptor for the source document and multiple chunk descriptors for multiple sections of the source document, and provide access to the multimodal object for multiple AI agents configured to generate content experiences associated with the source document. For example, the content experience system 150 may provide access to the multimodal object for multiple AI agents configured to generate content experiences associated with the source document.

The Figures and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to ROMs, random access memories (RAMs), erasable programmable read-only memories (EPROMs), electrically erasable programmable read-only memories (EEPROMs), solid-state memory, flash memory, optical storage, magnetic storage, or other types of media/machine-readable medium suitable for storing electronic instructions.

The network 130 or cloud can be any network, ranging from a wired or wireless local area network (LAN) to a wired or wireless wide area network (WAN), to the Internet or some other public or private network, to a cellular or telecommunications (e.g., 4G, LTE, 5G, or 6G) network, and so on. While the connections between the various devices and the network 130 are shown as separate connections, these connections can be any kind of local, wide area, wired, or wireless network, public or private.

Further, any or all components depicted in the Figures described herein can be supported and/or implemented via one or more computing systems, servers, or cloud-based systems. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located at both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer, display device, machine or robot, or mobile or portable device, and thus, while certain hardware platforms are described herein, aspects of the system are equally applicable to nodes on a network. In some cases, the mobile device or portable device may represent the server portion, while the server may represent the client portion.

### Examples of the Context Experience System

As described herein, the context experience system 150 may operate to generate multimodal content experiences for users of a platform. For example, the system 140 may utilize a structured content format that incorporates unique identifiers for each content segment and establishes explicit connections both within individual content and across different types of content. These identifiers enable AI systems to link segments of one content type (e.g., a book) to corresponding segments in another context type (e.g., a video), and/or to identify how themes in one book relate to arguments presented in another book or piece of content.

By embedding these relationships into content metadata, the system 150 enables techniques and frameworks to perform cross-modal and cross-document analyses, such as techniques that align related content across multiple mediums, generating coherent multi-format (e.g., multimodal) derivatives or content, such as video-enhanced summaries, and creating interactive modules that seamlessly integrate text and visual explanations that are linked or tied together.

The system 150, therefore, may utilize cross-content connections to ensure that derivative works are both comprehensive and contextually accurate while enabling robust mechanisms for monetization and/or attribution. The system 150, therefore, may address limitations in traditional formats to unlock and/or realize new or enhanced workflows for creating dynamic, multi-, or cross-modal, content experiences, enhancing engagement and accessibility across diverse platforms and formats, among other benefits.

Further, in some examples, the context experience system 150 may generate content experiences that enable conversational engagement between the content and its users, allowing the users (e.g., readers and content consumers) to explore alternative perspectives, clarify meanings, and/or adjust comprehension difficulty levels in a real-time and dynamic manner. The system 150 may employ voice interaction, personalized recommendations, and collaborative tools to enhance content experience workflows for solo readers, study groups, families, book clubs, educational institutions, and so on. The system 150, therefore, transforms content limited to static consumption into content that is experiential and facilitates dynamic participation, fostering a deeper connection between readers and the content, among other benefits.

Also, the system 150 may engage content creators and publishers with an infrastructure that maintains content control while expanding engagement reach across platforms and formats (e.g., by streamlining the management of intellectual property and enforcing licensing agreements), For example, the system 150 may include functional modules that support integration with third parties, including local content developers, distributors, users, and others.

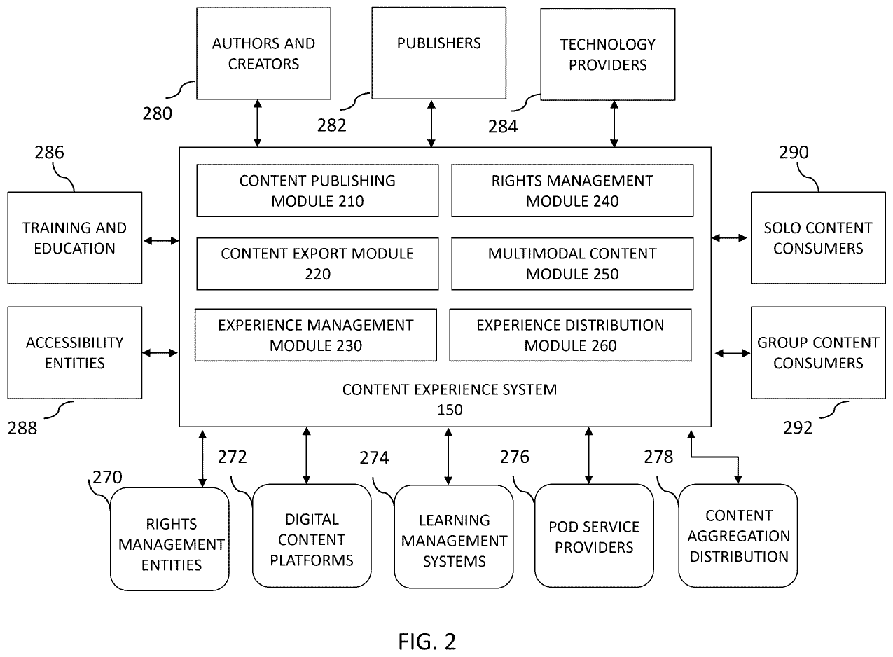

FIG. 2 is a block diagram illustrating example modules of the content experience system 150. The components and/or modules of the system 150 can be implemented with a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein.

A content publishing module 210 is configured and/or programmed to publish and/or transform content. For example, the content publishing module 210 enables authors, publishers, and/or content creators to upload source content (e.g., books, videos, articles, and so on) in various formats (e.g., PDF, EPUB, MP4). The content publishing module 210 may preprocess uploaded content by analyzing the structure of the content, enriching the content with metadata and/or embedding instructions to guide downstream AI processes.

The content publishing module 210 may optimize the content for further processing, ensuring compatibility with advanced or different AI models and tools. For example, the content publishing module 210 may generate an AI-ready content format (as described herein), which includes structured metadata and embedded guidance that directs how AI agents, (e.g., experience generation agents and/or interactive agents interpret and process the content to create consistent and accurate multimodal content experiences and derivative works. In some cases, the content publishing module 210 operates as an entry point for converting raw content into formats suitable for multimodal content generation and distribution.

A context export module 220 is configured and/or programmed to export AI-read content. For example, the context export module 220 may facilitate a seamless export of content transformed by the content publishing module 210. The module 220 may ensure that the enriched and AI-optimized content (e.g., in an AI-ready content format) is prepared for external integration, enabling technology providers (e.g., technology and AI service providers) 284 to create derivative works such as translations, summaries, or adaptations. In some cases, the exported content includes useful metadata, structural annotations, and/or embedded instructions to maximize compatibility and accuracy during generative AI processing. Further, the module 220 may facilitate the creation of new content experiences that are not natively supported by the system 150.

An experience management module 230 is configured and/or programmed to manage interactive multimodal content experiences. For example, the experience management module 230 may enable or provide dynamic, interactive engagement with content, allowing users to tailor their consumption experiences through real-time interactions. The module 230 may provide a rich set of interactive features, such as the ability to request specific actions or modifications to the content. For example, a user can ask the system 150 to begin reading a specific section of a book, and, during a playback of the book, ask the system 150 to pause the playback to inquire about the meaning of a term or concept and/or request an illustrative example to clarify a complex topic. The module 230 may also enable users to simplify text (e.g., for easier comprehension) and/or adjust the complexity of the content (e.g., to suit or match a knowledge level of the user).

In some cases, the experience management module 230 supports enhanced multimodal content experiences that are generated on demand. For example, a user may ask the system 150 to create a sub-book containing summaries of Chapter 1 and Chapter 2 of a book and/or request the generation of an activity book (e.g., five medium-level questions covering the first three sections of Chapter 5 of the book). The module 230 may automatically produce such requested content using embedded generation instructions within the content format and together with the instructions from the user. Thus, the module 230 may ensure that resulting outputs remain accurate, aligned with the source content, and consistent with the intent of the user, among other benefits.

The experience management module 230 may support other interactive experiences, such as taking notes during a reading session or integrating with external tools like calendars to schedule reading times or group discussions. For example, a user may ask the system 150 to set a reminder to finish a chapter before a scheduled discussion or to sync with their calendar to set aside dedicated reading time. In some cases, users may engage with an AI-powered avatar that acts as a virtual guide, providing personalized recommendations, answering questions, or leading the users through a structured reading journey. The module 230 may enable users to request short voice clips that highlight or explain specific passages, allowing the users to quickly revisit important insights or receive brief contextual explanations without navigating an entire text or chapter. Further, the system 150 may employ voice cloning technology to present the content in the voice of the author, creating an immersive experience that gives the impression of directly interacting with the author of the book, further enhancing engagement and personalization, among other benefits.

Thus, the experience management module 230 may ensure that content consumption is highly personalized, adaptable, and engaging, offering users improved control over content experiences and interactions. By providing such a wide range of capabilities, the module 230 may transform traditional content consumption into an interactive, immersive, and adaptive experience.

A rights management module 240 is configured and/or programmed to perform rights trading and management for original content and/or multimodal content experiences. For example, the rights management module 240 may control or manage the licensing, attribution, and/or trading of rights for original content, multimodal content experiences, derivative works, and so on. The module 240 may ensure that all content generated and distributed through the system 150 complies with copyright laws and licensing agreements, among other benefits.

In some cases, the rights management module 240 may integrate with the content publishing module 210 access the AI-ready content format and/or with external rights management systems to facilitate interoperability with industry-standard licensing frameworks. Through these integrations, the module 240 maintains accurate and verifiable tracking of content usage, transformation events, derivative generation, and distribution activities. The AI-ready content format, generated by the content publishing module 210, enables such capabilities by embedding canonical identifiers, attribution markers, and rights-related metadata directly within the transformed content. Such structured information supports fine-grained monitoring of how specific portions of the content are processed, referenced, or incorporated into derivative or multimodal experiences, enabling precise attribution, and ensuring that rights holders are properly recognized and compensated for all downstream uses.

In some cases, the rights management module 240 may support innovative trading mechanisms, such as the use of virtual currencies, cryptocurrencies, or Non-Fungible Tokens (NFTs), allowing rights to be securely and efficiently traded between parties. For example, a publisher can use the module 240 to license generated content experiences, such as translations, audiobooks, or interactive timelines, or to monetize specific sections of derivative works. By enabling granular control over rights management, the module 240 may ensure that all stakeholders, including authors, publishers, and service providers, are compensated fairly and transparently for their contributions, among other benefits.

A multimodal content module 250 is configured and/or programmed to generate multimodal content experiences. For example, the multimodal content module 250 may create a diverse range or set of content experiences (e.g., derivative works) from the transformed source content. Leveraging advanced or different AI capabilities, the module 250 generates content experiences, such as text summaries, audiobooks, visual timelines, interactive Q&A sessions, guided learning modules, and so on.

In some cases, the multimodal content module 250 employs specialized AI agents, connected to large multimodal AI models, and integrates experience-specific tools (e.g., dictionaries, thesauri, and style guides) to ensure accuracy and relevance within generated outputs. Additionally, the module 250 may utilize content-specific and generation-specific memory systems to maintain context consistency, avoid redundancy, and enhance the coherence of derivative works. For example, the module 250 may generate an audiobook narrated in an AI-cloned voice resembling the author, may simplify complex text for easier comprehension, and/or create interactive visuals to explain intricate topics. By supporting a wide range of formats and modalities, the multimodal content module 250 ensures that the generated experiences cater to the diverse needs of users, whether individuals or groups, among other benefits.

While the experience management module 230 generates or modifies content experiences according to direct user instructions, the multimodal content module 250 may operate (e.g., offline or in a separate workflow) to produce fully validated, high-quality derivative works. The multimodal content module 250 may utilize multiple rounds of processes, incorporating internal validation steps, quality checks, and iterative refinement by various system agents before the experiences are released for user consumption. For example, the module 250 may employ an agent-based architectures that focuses on producing structured, durable, system-curated derivative experiences (e.g., whereas the module 230 may supports immediate, user-driven, on-demand interactions).

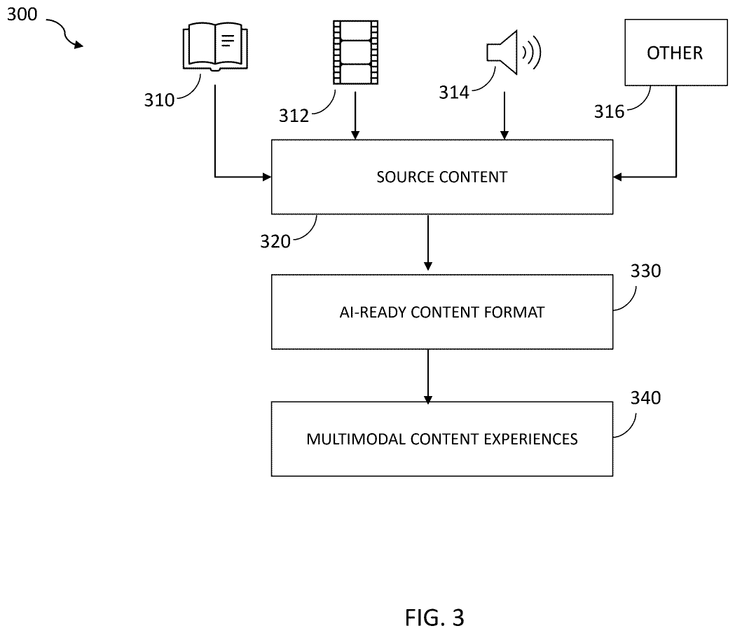

FIG. 3 is a flow diagram illustrating an example transformation 300 of source content to multimodal content experiences. The content generation system 150 may process various types of source content 320, including text 310 (e.g., books, articles, and so on) in different formats (e.g., PDF, EPUB), video 312 in different formats (e.g., MP4, MOV), audio 314 in different formats (e.g., MP3, WAV), and other mixed media or multimedia content 316 (e.g., diagrams, maps, and so on.

The system 150, as described herein, may convert the source content 320 into content that is formatted with an AI-Ready content format 330. For example, the AI-Ready content format 330 may include or embed structured metadata, canonical identifiers, and/or generation instructions that support both offline and interactive content creation. In some cases, the multimodal content module 250, using the AI-Ready content format 330, may produce fully curated, validated, and system-generated derivative works or multimodal content experiences 340 through offline workflows that may occur in multiple rounds of refinement. In other cases, the experience management module 230, using the AI-Ready content format 330, may generate or modify the multimodal content experiences 340 according to direct user instructions, enabling on-demand interactive outputs and adaptive multimodal responses.

The multimodal content experiences 340 may include a variety of different content types, including articles and blogs, summaries and highlights, translated e-books, audiobooks and narrated stories, podcasts, course-style content, illustrated content, quizzes and workbooks, narratives, and so on.

As a first example, articles and blogs may be summarized or reformatted versions of the content for quick reading or publication. They may include sub-books or other derivative compilations that are created by extracting, reorganizing, reformatting, or generating material derived from the original or transformed content. Such compilations may combine or adapt content segments, summaries, generated explanations, or other multimodal elements to support focused, thematic, personalized, or otherwise purpose-specific use cases.

As another example, summaries and highlights may be condensed versions of the original content, highlighting key points or chapters. They may include derivative or adapted forms that restructure, reinterpret, or augment the source material by combining extracted segments, generated explanations, thematic overviews, or multimodal elements. Such outputs can be tailored to provide concise, purpose-specific, or personalized representations of the underlying content while preserving its core meaning and intent.

As another example, translated e-books are generated e-books in multiple languages, ensuring accessibility and localization while preserving the integrity and context of the original content. The translations may include adapted, reformatted, or culturally localized versions that integrate generated clarifications, stylistic adjustments, or multimodal enhancements to maintain coherence and relevance across different linguistic and regional settings. Such outputs can be tailored to support personalized reading preferences, domain-specific terminology, or educational requirements while remaining faithful to the source material.

As another example, audio books and narrated stories may be generated using AI-driven text-to-speech technology, including the options for narration in the author's voice or multi-character narration for storytelling. Such audio experiences may incorporate adaptive narration styles, expressive prosody, localized pronunciations, or voice personas tailored to user preferences or content type. The audio experiences may include generated explanations, contextual interludes, sound design elements, or other multimodal enhancements to create immersive, personalized, or purpose-specific listening experiences while remaining faithful to the underlying material.

As another example, podcasts may be audio adaptations of content designed for on-the-go consumption. The podcasts may include curated or generated discussions, commentary segments, thematic explorations, or simulated interviews conducted through AI agents. In some cases, the system 150 may generate podcasts using AI-driven narration in a neutral voice, personalized voice personas, or a cloned version of the author's voice to enhance authenticity and engagement. Podcast outputs can incorporate inserted explanations, contextual summaries, or other multimodal enhancements and may be tailored to user preferences, learning objectives, or domain-specific requirements.

As another example, course style content may include structured educational modules with interactive elements, such as quizzes and/or learning paths. The content may include generated explanations, adaptive lessons, guided learning sequences, multimodal instructional materials, or personalized study plans derived from the underlying content. Course-style outputs can be tailored to different skill levels, learning objectives, or instructional formats and may incorporate assessments, feedback loops, or agent-led guidance to support individualized or group learning experiences.

As another example, illustrated content can include visual representations of the material, including diagrams, infographics, and annotated images. The content may include AI-generated visual summaries, conceptual diagrams, contextual illustrations, or multimodal visualizations that reinterpret or augment the underlying content. Illustrated outputs can be adapted to different learning goals, user preferences, or thematic focuses and may integrate explanatory overlays, interactive elements, or dynamically generated visual expansions to enhance comprehension and engagement.

As another example, quizzes and workbooks may be supplementary materials designed to reinforce learning and comprehension. For example, quizzes assess knowledge retention with multiple-choice or open-ended questions and may also include scenario-based items, adaptive assessments, or other generated evaluation formats derived from the underlying content. Similarly, workbooks provide exercises and guided activities tailored to the content, and may incorporate generated explanations, multimodal elements, personalized practice tasks, or structured activities that support thematic, skill-level-specific, or purpose-driven learning.

As another example, narratives may include interactive storytelling formats (e.g., choose-your-own-path) where users can make decisions to navigate through different story arcs. The narratives may include dynamically generated branches, adaptive plot progressions, or agent-curated pathways that respond to user preferences, learning objectives, or thematic focus. Outputs can incorporate multimodal elements, contextual explanations, or personalized narrative cues, allowing the system 150 to create tailored, immersive, and purpose-specific interactive experiences derived from the underlying content.

Thus, in some examples, the system 150, via the experience management module 230 and/or the multimodal content module 250, may ensure that each content experience is optimized for its target format while maintaining the integrity and intent of the source material. Together, the modules 230, 250 enable personalized, multimodal engagement with content, transforming traditional media into dynamic and versatile formats suitable for a wide range of users and applications, among other benefits.

Back to FIG. 2, an experience distribution module 260 is configured and/or programmed to distribute content experiences. For example, the experience distribution module 260 delivers content experiences to external platforms and systems, enabling their accessibility and scalability. While the experience management module 230 facilitates user-driven engagement with the generated experiences, the experience distribution module 260 ensures that the diverse content experiences generated by the multimodal content module 250 (e.g., audiobooks, summaries, or interactive narratives) are distributed as distinct, standalone formats that can be integrated into various external tools and platforms.

In some examples, various groups or entities may interact with the content experience system 150, including authors and creators 280, publishers 282, the technology and AI service providers 284, solo content consumers 290, group content consumers 292, training providers and educational institutions 286, and accessibility advocates 288 or entities.

The authors and creators 280 are primary originators of source content (e.g., the source content 320), including books, articles, videos, or other media. Via the content publishing module 210, an author may upload content in various types or formats (e.g., text, audio, video) and ensure that the content is enriched and transformed for further use by the system 150. In some cases, authors, creators, or other users may be responsible for providing the foundational or source material that the system 150 processes into multimodal experiences and derivative works. Additionally, authors and creators 280 may leverage the system 150 to retain control over their intellectual property and track the licensing and distribution of their content (e.g., via the rights management module 240).

The publishers 282 may leverage the system 150 to enhance, manage, and distribute content. Via the content publishing module 210, the publishers 282 may refine and prepare source content for multimodal experience generation. The publishers 282 may also utilize the content export module 220 to collaborate with external technology and AI service providers for generating derivative works.

In some cases, publishers 282, using the rights management module 240, may define and/or manage licensing terms for both original and derivative works, ensuring proper attribution and compensation. Via the experience distribution module 260, the publishers 282 may distribute refined and multimodal experiences, such as audiobooks, translated e-books, course-style content, and so on, to various digital platforms, ensuring widespread reach to individual and group consumers.

The technology and AI service providers 284 may utilize the system 150 to access AI-ready content exported via the content export module 220. Such providers may create specialized visualizations and innovative content experiences tailored to unique book types. For example, the providers 284 may develop interactive 3D models for scientific texts, immersive augmented reality (AR) or extended reality (XR) experiences for graphic novels, or adaptive learning modules for technical manuals. By leveraging the transformed and enriched content, the providers 284 enable new and creative ways for users to engage with content, catering to niche audiences and specialized domains, among other benefits.

The solo content consumers 290 are individual users who interact with the system 150 to access personalized and multimodal content experiences. These users interact with the experience management module 230 to engage with content in various ways, such as listening to audiobooks, reading summaries, exploring visual illustrations, and/or participating in interactive Q&A sessions. Solo content consumers 290 may benefit from features like voice interaction, personalized reading recommendations, and the ability to adjust the complexity of the content to match their preferences. They may have access to tools for taking notes, bookmarking, and setting reminders, making their content consumption both engaging and adaptive to their individual needs.

The group content consumers 292 are entities such as study groups, book clubs, families, or collaborative teams who collectively engage with the system 150. These groups may leverage the experience management module 230 to share and interact with content experiences in a collaborative manner. The groups may synchronize their progress, annotate shared content, and participate in group discussions facilitated by interactive tools such as Q&A modules or guided reading timelines. Additionally, AI agents of the system 150 may act as a moderator for the group, guiding discussions, answering questions, highlighting key points, and even suggesting topics for deeper exploration. Such features may foster a seamless collaboration and dynamic group engagement, making the system a valuable tool for shared learning and exploration.

The training providers and educational institutions 286 may use the system 150 to deliver structured and interactive learning experiences to students and trainees. They may leverage the experience management module 230 to deliver content directly to students and study groups. For example, instructors can use the system 150 to set up collaborative group activities, with an AI agent acting as a facilitator for discussions and knowledge sharing. Additionally, uses may create customized educational modules, such as course-style content, quizzes, and guided tutorials, from the source material. The experience distribution module 260, in some cases, may provide access to content.

The accessibility advocates 288, such as non-profit organizations, public sector agencies, or other entities, may utilize the system 150 to make content accessible to individuals with disabilities, special needs, impairments, or other factors. The accessibility advocates 288 may utilize features in the experience management module 230 to provide alternative or accessible formats such as audiobooks, simplified text, and illustrated guides. The system 150, via its AI agents, may enable real-time adaptations, such as converting complex language into simpler forms or generating visual aids for individuals with cognitive challenges.

Other entities, as described herein, may interact with the content experience system 150. For example, rights management entities 270 may utilize the system 150 to oversee the licensing, tracking, and/or monetization of intellectual property associated with original and derivative works. The entities 270 may interact with the rights management module 240 to manage attribution, ensure compliance with copyright agreements, and facilitate rights trading (e.g., supporting mechanisms such as licensing through cryptocurrencies, virtual currencies, or NFTs).

As another example, digital content platforms 272 (e.g., e-book stores or vendors, audiobook platforms, online learning platforms), may use the system 150 to access and distribute the diverse content experiences generated by the multimodal content module 250. For example, the platforms 272 may integrate with the experience distribution module 260 to offer multimodal experiences, such as audiobooks, interactive narratives, and course-style modules, to their users. The system 150 may ensure that all content is distributed with the appropriate licensing and attribution, as defined by the rights management module 240. By partnering with the system 250, the digital content platforms 272 can expand their offerings and provide users with innovative and engaging content experiences.

As another example, learning management systems (LMSs) 274 may utilize the system 150 to integrate educational content experiences into their platforms. The LMSs 274 may interact with the experience distribution module 260 to provide students and educators with access to course-style content, interactive quizzes, and visual aids generated by the system 150. LMSs 274 may benefit from the ability to customize content for different learning paths and adapt experiences based on student progress. Such integration may enable educational institutions to deliver dynamic, multimodal content to enhance learning outcomes.

As another example, print-on-demand service providers 276 may interact with the experience distribution module 260 to produce high-quality printed or published materials, such as books, workbooks, and visual guides, based on the content experiences generated by the system 150. The system 150, therefore, can enable a scalable and efficient production of customized print materials tailored to user needs, such as large print books for visually impaired users or educational workbooks for training programs.

As another example, content aggregators and content distribution entities 278 may use the content experience system 150 to curate, bundle, and distribute a wide range of content experiences to broader markets. Via the experience distribution module 260, the entities 278 may gain access to multimodal content, including audiobooks, summaries, and illustrated guides. Further, such entities 278 can package content for specific audiences, such as educational institutions, corporate training programs, or entertainment platforms. The rights management supported by the system 150 may ensure that all aggregated and distributed content complies with licensing agreements, enabling efficient and ethical content distribution.

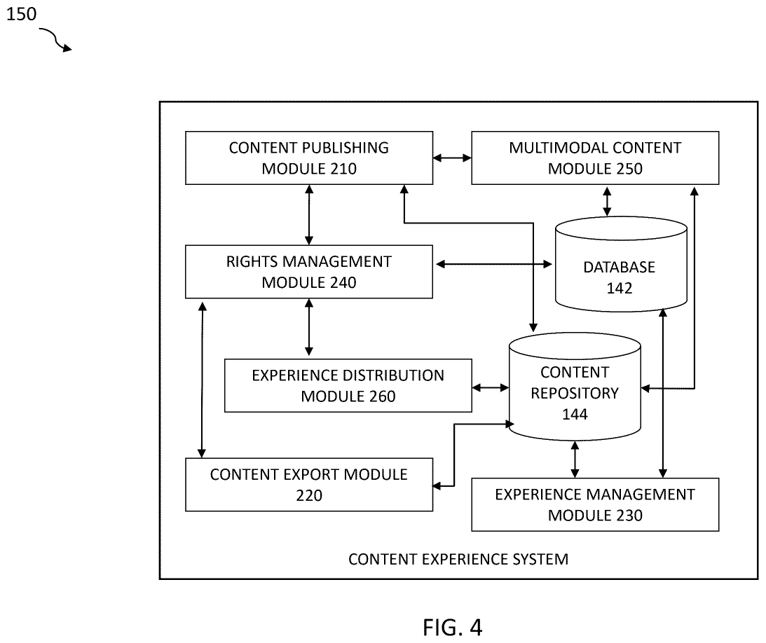

As described herein, in some examples, the content experience system 150 acts as a central hub, enabling seamless communication and coordination between all interconnected components. FIG. 4 is a block diagram illustrating example interactions between modules of the content experience system 150.

The content publishing module 210 may directly interface with the rights management module 240 to ensure that all published content complies with licensing requirements and includes metadata for downstream processing. The system 150 may prepare and store content in the content repository 144, where the content is accessible (e.g., retrievable) to other modules for further processing or distribution. As described herein, the modules 210-260 may represent logical functional components implemented through software services, distributed processes, orchestration layers, or other computational mechanisms. The integration between the modules 210-260n ensures that content is systematically enriched, validated, and stored in a structured format, ready for subsequent use by other components.

The multimodal content module 250 may retrieve content from the content repository 144 to create diverse content experience, such as summaries, audiobooks, visual aids, and so on. The module 250 may operate in coordination with the database 142 to access metadata and user preferences, ensuring that generated content aligns with specific requirements. Once generated, the module 250 may store the multimodal experiences in the content repository 144, where the experiences are available for distribution or interactive engagement. Such between the module 250, the content repository 144, and the database 142 facilitates efficiency in managing and updating content experiences.

The experience management module 230 interacts with both the content repository 144 and the database 142 to facilitate real-time user engagement with the generated content experiences. The module 230 may access, receive, or retrieve multimodal content from the content repository 144 and use data from the database 142, such as user preferences and interaction histories, to tailor the experience to individual or group requests. The module 230 enables dynamic interactions, such as voice-based queries, text-based prompts, annotations, in-context explanations, adaptive reading assistance, interactive visual elements, personalized guidance, and collaborative group activities, supporting seamless integration with the content generation and storage components. The module 230 operates as a logical processing layer that may be implemented through software services, distributed agents, orchestration pipelines, or other computational mechanisms. By maintaining bidirectional communication, the module 230 ensures that user interactions are captured and fed back into the system 150 to refine future experiences.

The experience distribution module 260 delivers generated content experiences to end users and third-party platforms. The module 260 may directly communicate with the content repository 144 to retrieve finalized content experiences and interacts with the rights management module 240 to verify compliance with licensing agreements and permissions. Thus, the module 260 may distribute authorized to appropriate platforms or users. Distribution may occur through user-facing applications, APIs, external services, export workflows, or integrated partner platforms, depending on system requirements. Functionally, the module 260 represents a logical distribution layer that may be implemented using software services, cloud-based delivery mechanisms, or other computational or communication infrastructures suited for scalable and secure content dissemination.

The content export module 220 provides external platforms, such as third-party technology providers and AI service providers, with access to transformed content in an optimized format. The module 220 interfaces with the content publishing module 210 to export AI-ready content that includes metadata and formatting enhancements, ensuring compatibility with external tools and workflows. The module 220 may also interact with the rights management module 240 to ensure that exported content adheres to licensing agreements and permissions. By providing external systems with structured, enriched content, the module 220 enables seamless integration with external AI applications and the creation of innovative content experiences beyond the platform's native capabilities.

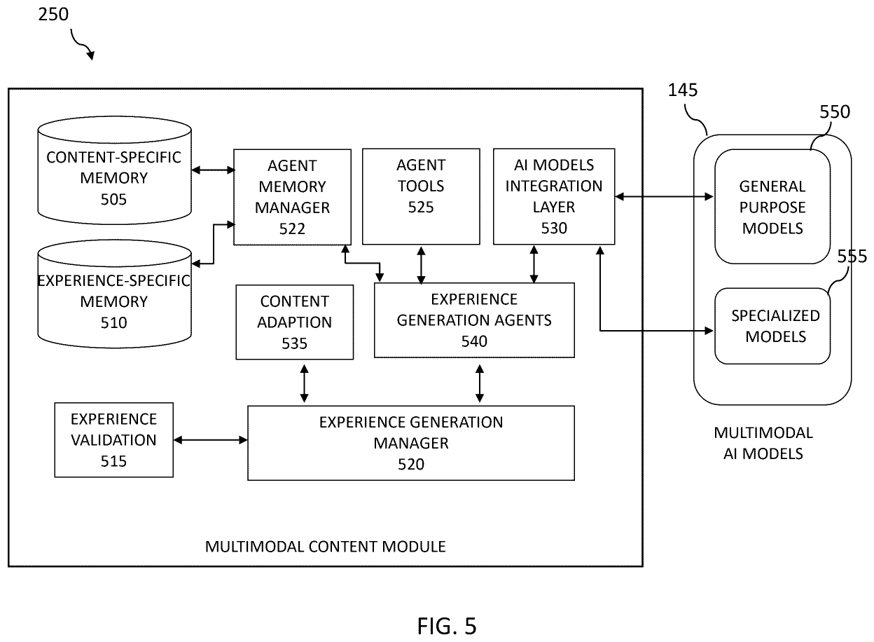

As described herein, the multimodal content module 250 may generate diverse and personalized content experiences by leveraging multiple interconnected components. FIG. 5 is a block diagram illustrating example components of the multimodal content module 250. The module 250 includes various AI agents, including experience generation agents 540, which operate via capabilities provided by an AI models integration layer 530. The layer 530 enables the AI agents to interface with various AI systems or multimodal AI models, including general purpose multimodal AI models 550, specialized (or domain-specific) models 555, and/or other AI resources suitable for a task or operation. The layer 530 may dynamically select, combine, or orchestrate these AI systems based on the requirements of the specific content experience being generated.

In some cases, an AI agent may be an AI-driven computational entity capable of interpreting inputs, reasoning over context, making decisions, generating and/or executing plans, and/or invoking internal or external tools to perform tasks. AI Agents may rely on large language models (LLMs), neural networks (NNs), multimodal AI systems, rule-based mechanisms, reinforcement-learning strategies, or other current or future AI technologies. For example, when an AI agent is tasked with translating a document into a particular language, the AI agent may utilize an AI system that is optimized or trained to produce high-quality output in that linguistic domain. If the ask involves summarization, reasoning, or multimodal transformation, the AI models integration layer 530 may route the request through a general-purpose model or an orchestrated combination of models. Such dynamic orchestration of AI capabilities ensures that the AI agents deliver accurate and contextually appropriate content experiences tailored to a wide range of needs.

Agent tools 525 may include specialized utilities that enhance the functionality of the experience generation agents 540. The agent tools 525 provide the AI agents with additional capabilities tailored to specific tasks, such as dictionary access for translations, thesaurus integration for generating diverse text outputs, and/or visual processing tools for creating illustrative content. The agent tools 525 may function as logical utilities, external services, model-assisted processors, or other computational resources that the AI agents can call to perform these functionalities seamlessly. By working in conjunction with the AI models integration layer 530, the agent tools 525 may enable the AI agents to perform complex, multi-step operations with precision and efficiency, supporting a wide variety of generation workflows and multimodal transformations, enriching the generated content experiences.

An agent memory manager 522 may manage and organize the contextual knowledge useful for content generation. The manager 522 interfaces with two distinct but potentially overlapping memory components: content-specific memory 505 and experience-specific memory 510. The content-specific memory 505 stores information related to the processing of the content, ensuring consistency and accuracy across tasks. For example, if a specific concept in a document was translated using certain words, the content-specific memory 505 ensures that all subsequent translations of the concept use the same terminology. This includes structural details, formatting requirements, metadata relationships, domain-specific constraints, and other rules or patterns relevant to the underlying content. Such memory components may function as logical knowledge stores or contextual reference layers that may be implemented through databases, vector stores, distributed memory services, or other computational memory mechanisms.

The experience-specific memory 510 may store information related to how to perform specific tasks, such as translation or workbook generation. The memory 510 may support task-specific workflows, decision heuristics, and previous examples of successful task execution. The memory 510 may also store procedural patterns, operational constraints, agent-level strategies, or other forms of task-related contextual knowledge that support multi-step or adaptive generation processes. Together, the memories 505, 510 allow the system 150 to combine content-specific and task-specific knowledge, delivering consistent and high-quality results tailored to the needs of the user.

In some cases, such as when a particular type of content requires or relies on task-specific instructions, the two memories 505, 510 may overlap. For example, experience-related guidelines for translating a highly technical book may include both the structural details of the content type and the workflow used for accurate translation. Such overlap or combination enables AI agents to effectively combine content-specific and task-specific knowledge, tailoring their operations for optimal results while maintaining consistency and quality.

A content adaptation module 535 facilitates generated experiences to align with the target audience, content-specific requirements, and an intended context. Rather than directly modifying the content, the module 535 provides tailored instructions to the experience generation agents 540, guiding the agents on how to adjust the content during the generation process. The instructions may include criteria, such as adjusting complexity, refining tone, or optimizing formatting. For example, the module 535 may direct the AI agents to simplify technical jargon for a broader audience or structure an audiobook to incorporate interactive elements. Additional adaptation scenarios may include modernizing outdated language in historical texts, converting measurements into different unit systems (e.g., switching between imperial and metric), or applying cultural adaptation rules to remove or clarify culturally sensitive references.

The content adaptation module 535 may further include rule sets, preference profiles, contextual constraints, or adaptive transformation guidelines that support personalization, accessibility adjustments, modality-specific refinements, or other content-shaping requirements. Such adaptation directives function as abstract logical specifications and may be generated, retrieved, or dynamically composed based on system knowledge, user input, or task objectives.

An experience validation module 515 may evaluate the generated experiences for quality, consistency, and compliance with predefined requirements. The module 515 may cross-reference the generated outputs against benchmarks stored in the memories 505, 510 to verify that the generated content aligns with expectations. For example, the module 515 may validate that a translation adheres to grammatical rules and retains the original meaning, or that a summary effectively highlights the most critical aspects of the source material. Validation may also include checks for structural correctness, adherence to formatting or accessibility guidelines, preservation of narrative coherence, or compliance with cultural or domain-specific constraints.

In some cases, the validation process may include human-in-the-loop verification, where human reviewers assess and refine the generated outputs to ensure the highest quality, particularly for complex or nuanced tasks. A human-AI hybrid approach may be applied selectively or continuously, depending on the task, confidence thresholds, or regulatory requirements, and ensure that high-quality experiences are passed on to an experience generation manager 520 for final delivery or storage.

The experience generation manager 520 may manage or oversee the content generation process, coordinating the functionality of the components of the multimodal content module 250. The manager 520 may integrate the outputs from the content adaptation module 535 and the experience validation module 515. The manager 520 may orchestrate task sequencing, manage dependencies, handle retries or fallback strategies, and apply routing logic to ensure that each generation workflow is executed efficiently and consistently. Further, the manager 520 serves as the interface between the multimodal content module 250 and other modules or components of the system 150, such as the content repository 144 and/or experience management module 230, enabling the delivery of the validated experiences to end users or third-party systems. Functionally, the manager may act as an abstract coordination layer that may be implemented through orchestration services, workflow engines, agent controllers, or other computational mechanisms suited for managing complex multimodal generation pipelines.

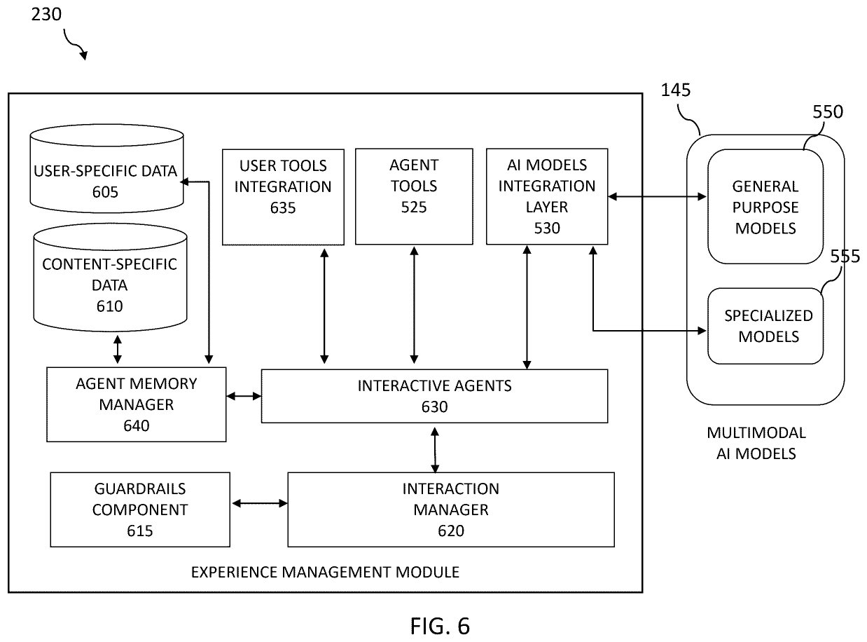

As described herein, the experience management module 230 may facilitate dynamic, user-driven interactions with content through intelligent AI agents and tools. The module 230 can integrate various components to enable personalized, real-time experiences, adapting to both user preferences and content-specific requirements. FIG. 6 is a block diagram illustrating example components of the experience management module 230.

The experience management module 230 may include interactive agents 630 that serve as a primary interface for engaging with users. The interactive agents 630 may be powered or supported by the AI models integration layer 530, enabling the AI agents to access and utilize one or more AI systems, including the general-purpose multimodal models 550, the specialized or domain-specific models 555, and/or other AI components suited for the interaction task, to perform tasks such as answering questions, simplifying text, or generating summaries. Such integration ensures that the AI agents are equipped with flexible reasoning capabilities and task-specific competencies, enabling them to address a wide range of user needs.

The agent tools 525, as described herein, may enhance the functionality of the interactive agents 630 by providing specialized utilities tailored for a wide range of interactive tasks. The agent tools 525 may include calendars for scheduling reading sessions, note-taking functionalities for capturing key points, annotation tools for highlighting and organizing insights, tools to create interactive illustrations on demand and search tools to locate additional material and videos related to the content being read or discussed. The agent tools 525 may function as logical utilities, external services, AI-assisted components, or other computational resources that support task execution, adaptive interaction, or multimodal content manipulation. By integrating with the AI models integration layer 530, the agent tools 525 support AI agents executing user-driven operations with precision, leveraging AI systems to support planning, reasoning, transformation, or retrieval tasks, and catering to the requests or needs of both individual users and collaborative groups.

A user tools integration module 635 may support a seamless connectivity between the interactive agents 630 and external applications (e.g., applications often used by users). For example, the module 635 may enable users to link the system 150 to their calendars, email platforms, or collaborative tools to create a more cohesive experience. The module 635 may integrate with a wide range of external services, device capabilities, or third-party applications, enabling the system 150 to access contextual information, trigger user-initiated actions, or synchronize content across environments. Thus, in some cases, the module 635 may connect gap the system's capabilities and the external tools users rely on, ensuring smooth workflows and enhanced productivity during interactions. Functionally, the module 635 operates as an abstract integration layer that may be implemented through APIs, connectors, service adapters, or other mechanisms that support interoperability and dynamic user-driven workflows.

An agent memory manager 640 may support the interactive agents 630 by organizing and managing contextual data in real-time. The manager 640 interfaces or accesses user-specific data 605 to access personalized user preferences, history, and profiles, ensuring that interactions are tailored to individual users and/or content-specific data 610 to provide content-related context, such as key themes or chapter relationships, enabling the AI agents to deliver more informed and relevant responses during interactions. The manager 640 may coordinate multiple forms of contextual information, such as interaction histories, conversational state, task-progress markers, or system-generated insights, to support adaptive, multi-step user experiences. The memory structures (e.g., user-specific data 605 and content-specific data 610) may operate as abstract functional components and may be implemented through databases, vector stores, knowledge bases, distributed memory layers, or other computational mechanisms suited for maintaining dynamic, context-aware information.

A guardrails component 615 or module can ensure or support interactions facilitated by the interactive agents 630 adhere to predefined safety, ethical, and/or contextual guidelines.

The component 615 may validate user inputs and AI agent outputs to ensure compliance with content policies, prevent inappropriate responses, and maintain a high standard of interaction quality. For example, the component 615 may flag or block potentially harmful content during a discussion or ensure that sensitive topics are handled with care. The guardrails component 615 may incorporate policy rules, contextual constraints, classification mechanisms, filtering logic, or AI-assisted evaluation methods to enforce safe and appropriate behavior across diverse interaction scenarios. By acting as a real-time monitor, the guardrails component 615 enhances the trustworthiness and reliability of the system 150, providing users with a secure and consistent experience. The component 615, like other modules described herein, functions as an abstract safety layer that may be implemented using rule-based systems, AI-driven moderation tools, external safety services, or other computational mechanisms designed to uphold system integrity and user well-being.

An interaction manager 620 may orchestrate the flow of communication between the interactive agents 630 and external systems or tools. The manager 620 can coordinate user requests, manage agent responses, and ensure that the appropriate tools or integrations are engaged for specific tasks. Additionally, the interaction manager 620 may handle interactions with other modules or components of the system 150, such as retrieving user-specific or content-specific data from the database 142, accessing generated or transformed content from the content repository 144, and/or managing requests from client applications 115A-B and 125.

The interaction manager 620 may also interface with additional system services, APIs, or distributed components to obtain contextual information, trigger workflows, or route tasks to the appropriate computational resources. Along with the guardrails component 615, the interaction manager 620 validates interactions and ensure compliance with predefined guidelines. For example, before sending a generated response to the user, the interaction manager 620 may pass the response through the guardrails component 615 to confirm that the output meets safety, ethical, and contextual standards. Such integration ensures that all interactions are secure, compliant, and high-quality while maintaining seamless communication across the system. As described herein, the interaction manager 620 may be implemented through orchestration services, middleware components, message-routing systems, or other mechanisms that enable seamless communication across the system 150.

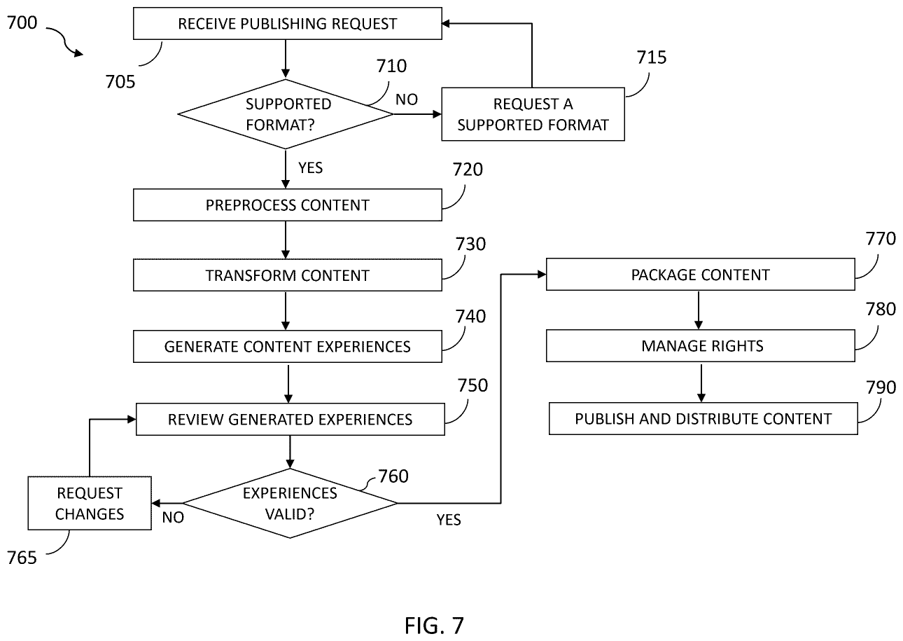

The content experience system 150, as described herein, may perform various processes, operations or workflows associated with the publishing, transformation, and/or distribution of content, such as multimodal content experiences. FIG. 7 is a flow diagram illustrating a method 700 for providing multimodal content experiences to users. The method 700 may be performed by the content experience system 150 and, accordingly, is described herein merely by way of reference thereto. It will be appreciated that the method 700 may be performed on any suitable hardware.

At operation 705, the content experience system 150 receives a publishing request from a user, such as an author, publisher, or content creator. For example, the content publishing module 210 may access, receive, and/or manage the request, such as by processing received content for various outputs.

At operation 710, the content experience system 150 determines whether the received content is in a supported format. A supported format may include PDF, EPUB, or another recognized publishing standard or format. The system 150 may apply format-detection logic, metadata inspection, or other mechanisms capable of determining whether the input content conforms to acceptable ingestion criteria. When the content is not in a supported format, the method 700 proceeds to operation 715, where the system 150 sends a request to provide a supported format.

When the content is in a supported format (or otherwise validated), the method, in operation 720, preprocessed the content. For example, the system 150 may analyze the content to extract key structural and/or metadata elements, such as chapters, sections, or keywords. The system 105 may select or verify metadata, such as author names, author identifiers, or publication details, using trusted or verified online databases or external reference sources.

In some cases, the system 150 may employ reasoning capabilities provided by AI systems to compare, reconcile, or unify titles, authors, identifiers, and other metadata attributes to ensure accuracy and consistency. Additional preprocessing may include tasks such as detecting layout patterns, parsing embedded media, identifying semantic relationships, isolating formatting cues, or performing normalization to resolve inconsistencies across sources. Thus, the system 150, in operation 720, may ensure that the content is prepared for efficient transformation and aligns with various processing requirements, regardless of the specific tools, algorithms, or pipelines used to execute these operations.

At operation 730, the content experience system 150 transforms the content. For example, the system 150 may enrich the content by embedding metadata, adding instructions for AI agents, and/or reformatting the content to make it AI-ready. For example, transformation may include generating structural markers, assigning canonical identifiers, linking related content segments, and/or incorporating guidance rules that inform downstream reasoning or generation processes. The system 150 apply normalization, multimodal alignment, and/or semantic enhancement techniques to ensure that the transformed output is coherent and machine interpretable. Such a transformation ensures that the content is optimized for generating various multimodal experiences, such as summaries, translations, or audiobooks, with the specific structure and components of the transformed output described with respect to an AI-ready content format (e.g., an aiBook format), as described herein.

At operation 740, the content experience system 150 system 150, via the multimodal content module 250, may use transformed content to create or generate multimodal content experiences. The multimodal content experiences, which can be redistributed across various platforms, include translations, summaries, audiobooks, course-style modules, and/or other derivatives or complementary content. The module 250 may employ AI-driven generation processes, agent-based workflows, and orchestration mechanisms to ensure that the generated experiences are accurate, high-quality, and suitable for distribution. Depending on the task, the system 150 may leverage multiple AI systems, predefined transformation rules, memory-assisted reasoning, or task-specific pipelines to create outputs that align with user needs, content requirements, and downstream distribution constraints.

At operation 750, the content experience system 150 reviews the content experiences. For example, the system 150, via the experience validation module 515, may review and/or assess the content experiences for quality, consistency, and compliance with user-specified requirements or system benchmarks. The module 515 may utilize automated validation checks based on predefined rules, AI-assisted evaluation methods, or contextual constraints, as well as human-in-the-loop verification to ensure the experiences meet the desired standards.

At operation 760, the content experience system 150, based on the review, determines whether the generated experiences are valid. When the experiences are not valid (e.g., issues are identified), the system 150, at operation 765, requests modifications or changes. At this step, users and/or other entities, via the experience generation agents 540 may refine the generated content experiences. The system 150 may perform an iterative loop until the output satisfies applied criteria for correctness, safety, and usability.

Once the content experiences are approved or approved, the method 700 proceed to operation 770, and the content experience system 150 prepares the generated content experiences for distribution by bundling them into the appropriate formats for various platforms or end-user needs. The packing of content ensures that the content is accessible and compatible with the intended channels of distribution, such as digital platforms, learning management systems, or print-on-demand services. Packaging may involve generating platform-specific file structures, embedding metadata, applying formatting rules, or producing multimodal bundles that combine text, audio, visual, or interactive elements depending on distribution requirements.

The system 150 may store packaged content in the content repository 144, where the content is accessible for distribution and/or for other system components, such as the experience management module 230, to enable dynamic and personalized user interactions. The packaging may include a modular preparation layer implemented through export pipelines, transformation services, or other computational mechanisms suited for delivering content in standardized or adaptive formats.

At operation 780, the content experience system 150 manages the rights of the content. For example, the rights management module 240 registers the content and the generated multimodal experiences, assigning permissions as identified by the publisher or author. The module 240 may ensure that generated content experiences comply with predefined licensing agreements and attribution requirements. The module 240 can verify permissions for distribution, manage rights across different platforms, and ensures appropriate compensation for stakeholders such as authors and publishers.

In some cases, the module 240 may validate contractual terms, apply usage restrictions, assign attribution metadata, reconcile rights across jurisdictions, or interact with external rights registries or licensing services. The module 240 may flag identified issues for resolution to maintain compliance and avoid unauthorized distribution. Thus, the module 240 may include or incorporate a flexible rights-governance layer that may be implemented through policy engines, rules-based evaluators, AI-assisted verification mechanisms, or other computational structures designed to enforce licensing and attribution requirements.

At operation 790, the content experience system 150 publishes and distributes the content. For example, the system 150 may distribute approved and packaged content to intended platforms or users. The system 150 may perform delivery to digital content platforms, integrate with learning management systems, or distribute through print-on-demand services. Distribution may occur through APIs, export pipelines, automated delivery channels, partner integrations, or other mechanisms suited for delivering content across diverse environments. The system 150 can ensure that the distribution aligns with licensing requirements, providing a seamless and controlled flow of content to the target audience. The system 150 may thus utilize an abstract delivery layer that may incorporate routing logic, access-control enforcement, auditing mechanisms, or other computational processes to ensure secure, compliant, and reliable content dissemination.

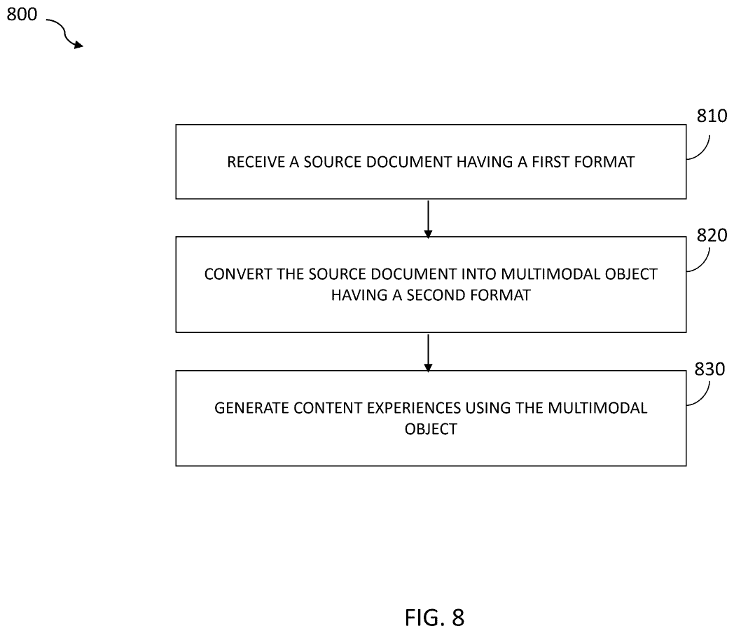

Thus, as described herein, the content experience system 150 may perform various processes or operations to generate multimodal objects and/or content experiences from source content. FIG. 8 is a flow diagram illustrating a method 800 for generating multimodal objects. The method 800 may be performed by the content experience system 150 and, accordingly, is described herein merely by way of reference thereto. It will be appreciated that the method 800 may be performed on any suitable hardware.

At operation 810, the content experience system 150 receives a source document having a first format. For example, the content publishing module 210 enables authors, publishers, and/or content creators to upload source content (e.g., books, videos, articles, and so on) in various formats (e.g., PDF, EPUB, MP4).

At operation 820, the content experience system 150 converts the source document into a multimodal object having a second format. For example, the content publishing module 210 may generate an AI-ready content format (as described herein), which includes structured metadata and embedded guidance that directs how AI agents, (e.g., experience generation agents and/or interactive agents interpret and process the content to create consistent and accurate multimodal content experiences and derivative works.

At operation 830, the content experience system 150 generates one or more multimodal content experiences using the multimodal object. For example, the experience management module 230 may enable or provide dynamic, interactive engagement with content, allowing users to tailor their consumption experiences through real-time interactions.

As another example, the multimodal content module 250 may create a diverse range or set of content experiences (e.g., derivative works) from the transformed source content. Leveraging advanced or different AI capabilities, the module 250 generates content experiences, such as text summaries, audiobooks, visual timelines, interactive Q&A sessions, guided learning modules, and so on.

### Examples of an Enhanced Book Format

In some examples, the systems and methods introduce a new and/or enhanced publishing format, such as an AI-ready content format (e.g., an aiBook format). The AI-ready content format may be a data structure and/or modular framework that is tailored for content associated with AI-driven operations, including translation, summarization, adaptive content generation, interactive user experiences, and so on.

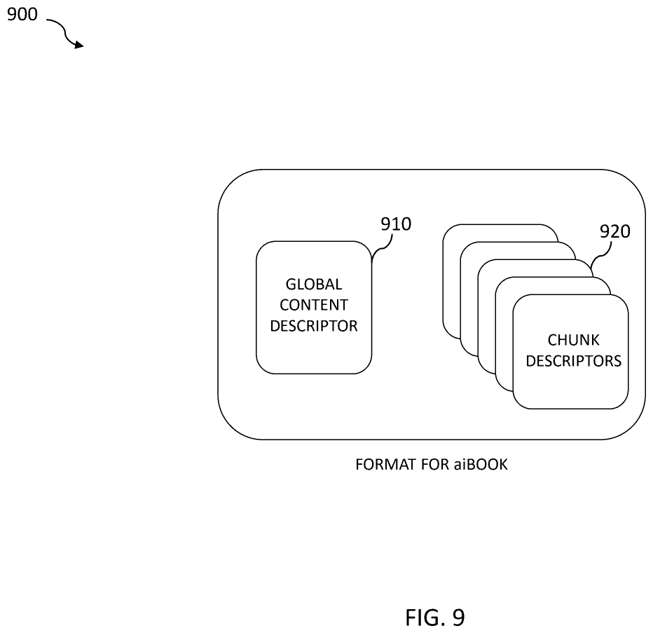

FIG. 9 is a diagram illustrating an example AI-ready content format 900 for content. The format 900 includes a global content descriptor 910 and multiple chunk descriptors 920. In some cases, a document, file, or data structure having the format 900 may be considered a multimodal object, which is accessible by AI agents to generate multimodal content experiences for the source documents. In some cases, a chunk descriptor 920 includes and/or provides descriptions and references to text, images, video files, audio files, and other content or content items.

The format 900 may also include information, metadata, or auxiliary structures, such as update logs that track enrichment actions or modifications, asset records used to reference translated or alternative media resources, style specifications that support consistent display across languages or modalities, and/or generation records that capture previously generated derivatives along with quality metrics or evaluation scores. Together, these components of the format 900 provide a representation of the structure, semantics, metadata, and transformation rules of a piece of content, enabling AI systems and AI agents to interpret, segment, reference, and process the content efficiently. Further, the components may be integrated to enable seamless content processing, referencing, and transformation by AI systems, while maintaining flexibility for diverse use cases, modalities, and future extensions.

In some cases, the global content descriptor 910 includes information associated with the organization and structure of the content. By encapsulating a comprehensive map of the content hierarchy, including chapters, sections, and sub-sections, the descriptor 910 enables users to interact seamlessly with the content through advanced or enhanced querying capabilities. For example, a user may ask to “read from a particular section,” “summarize Chapter 3,” or “explain the relationship between two specific concepts.” The system 150, via the descriptor 910, may ensure that the AI agents can identify and locate the requested portions of the content with precision, enhancing the accessibility and usability of the content across various platforms and devices. Beyond textual structures, the descriptor 910 may also represent relationships among multimodal elements, conceptual links, referential anchors, and logical groupings, enabling AI systems to understand and navigate the content regardless of its media type or underlying format.

Further, the global content descriptor 910 may include elements that support cross-referencing and navigation within the content, allowing AI systems to generate summaries or insights while maintaining fidelity to the original structure and thematic intent. The descriptor 910 may support contextual reasoning by exposing high-level relationships, dependencies, and hierarchical flows that guide AI-driven operations throughout the content lifecycle. Thus, the descriptor 910, which may operate on a macro-level for the content, facilitates contextual coherence in AI-driven operations, ensuring that responses, adaptations, or derivatives are aligned with the content's original purpose and flow. The descriptor 910, therefore, may link high-level organization and user-specific tasks, acting or operating as an abstract navigational and interpretive layer that supports intuitive, context-aware, and semantically aligned interactions across diverse user needs and application scenarios.

In some cases, the chunk descriptors 920 break the content into smaller, processable units or chunks, such as chapters, sections, paragraphs, and/or sub-points. Each chunk may be associated with detailed metadata, including a unique identifier, its textual content, and relationships to other chunks, such as logical or semantic connections. In addition to textual material, a chunk may also represent multimodal elements—such as images, audio regions, diagrams, captions, or time-aligned media segments—along with any associated metadata or contextual markers used for AI processing.

Furthermore, the chunk descriptors 920 may include specific AI notes, such as instructions for translation, summarization focus, or adaptive content generation tasks, tailored to the unique requirements of each chunk. The AI notes may encode transformation rules, reasoning cues, preference constraints, or modality-specific guidance that informs how AI agents interpret, adapt, or generate content related to the chunk.

In some cases, the chunk descriptors 920 may incorporate specialized schemas or metadata that guide the generation of audio-based experiences, including annotations for pauses, pacing cues, sound effects, character-specific voice attributes, emotional tone, or scene-based segmentation used to structure narration. This granular approach ensures that AI systems can process, adapt, or generate content with precision, maintaining contextual relevance and logical continuity. By treating each chunk as an abstract, self-describing unit, the system 150 supports fine-grained or micro-level operations, efficient referencing, and scalable multimodal processing across a wide range of applications.

Thus, the AI-ready content format 900, containing the global content descriptor 910 and chunk descriptors 920, may support or provide a balance of macro-level context and micro-level detail for content, enabling flexible, efficient, and intelligent content management. The format 900 can enhance the capability of AI agents to generate personalized user experiences, such as dynamic educational modules, interactive Q&A systems, and adaptive reading interfaces. It also supports multimodal and scenario-driven applications, including audiobook generation, visual augmentations, contextual explanations, and personalized transformations across different modes of consumption. The design of the format 900 may facilitate seamless interoperability across diverse content types and platforms, allowing AI systems to navigate, interpret, adapt, and generate content in a consistent and context-aware manner. The system 150, therefore, may utilize the format 900 when leveraging AI technologies in content creation, transformation, and/or delivery. Further details regarding information within the AI-ready content format 900 will now be discussed.

As described herein, the global content descriptor 910 provides a structured and comprehensive metadata framework that describes the overarching properties and organizational structure of a content piece (e.g., a multimodal content experience). The descriptor 910 may be a data structure or repository for essential or underlying metadata for the content, ensuring seamless usability across various AI-driven tasks such as summarization, translation, adaptive content generation, and user interaction. The descriptor 910 may be used with diverse content types (e.g., text, video, audio, and so on), and may include modality-specific fields, structural markers, semantic relationships, and conceptual linkages that enable AI systems to understand and navigate the content at a macro level. In some cases, the descriptor 910 may include or be based on specific requirements of different use cases, including reading, studying, and multimedia adaptation, supporting future extensions or domain-specific metadata structures as needed by evolving AI workflows or application scenarios.

In some cases, the global content descriptor 910 includes core or baseline metadata. The core metadata may include various attributes for the content, such as a title, creator, publication dates, language, subject, and/or source of the content. The core metadata may include an original format (e.g., EPUB, PDF) and rights associated with the content.

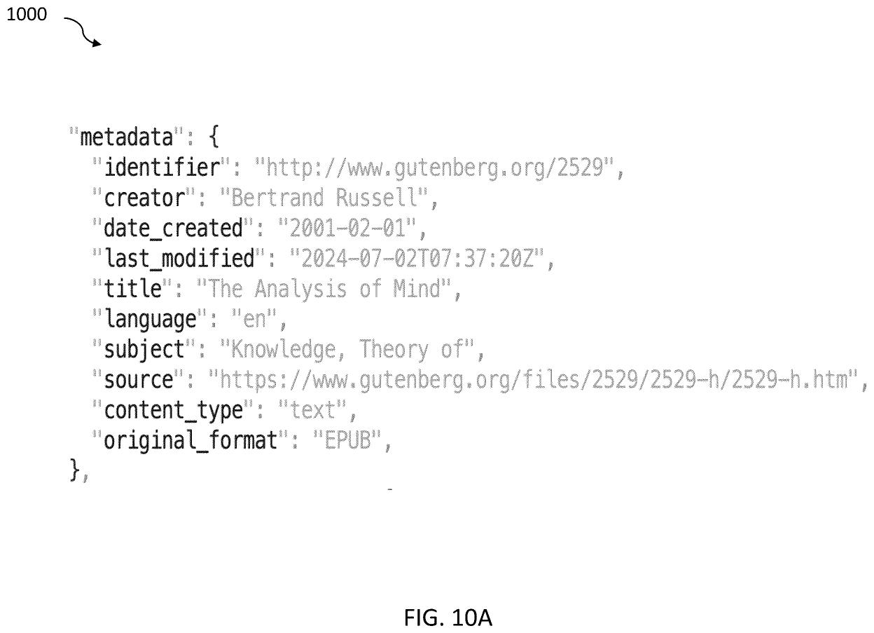

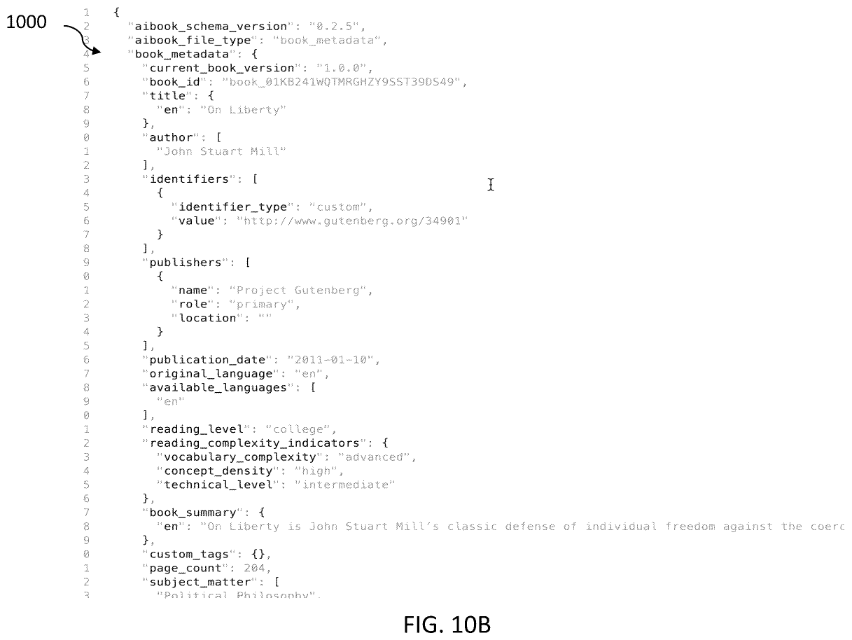

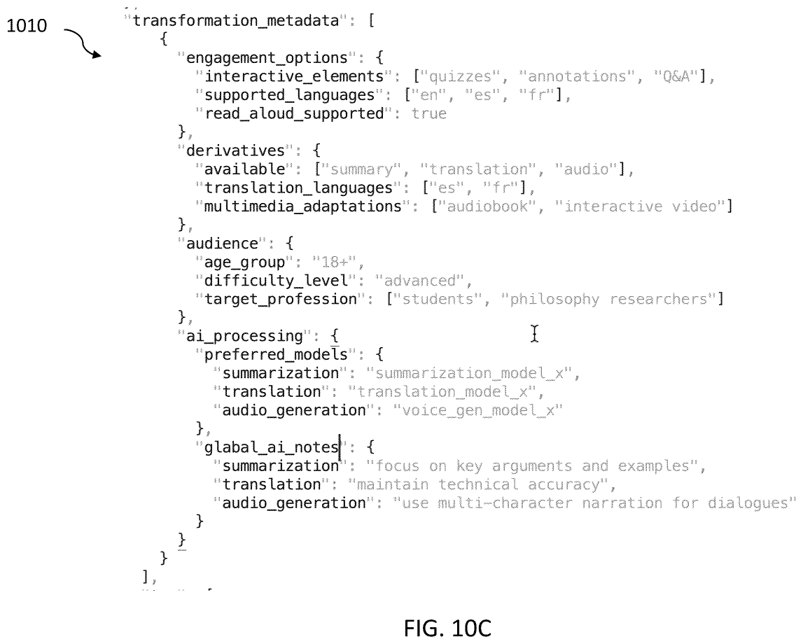

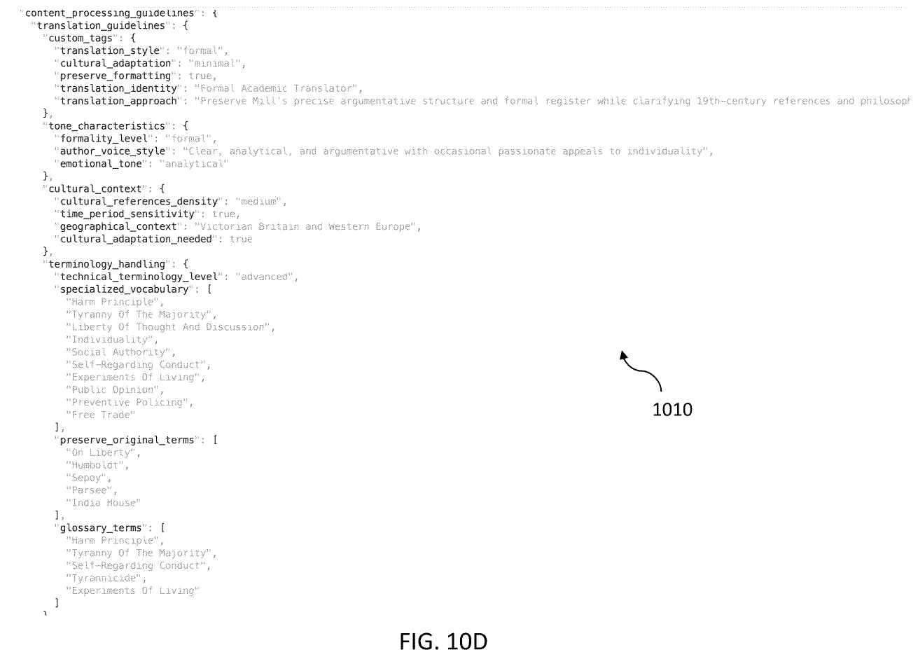

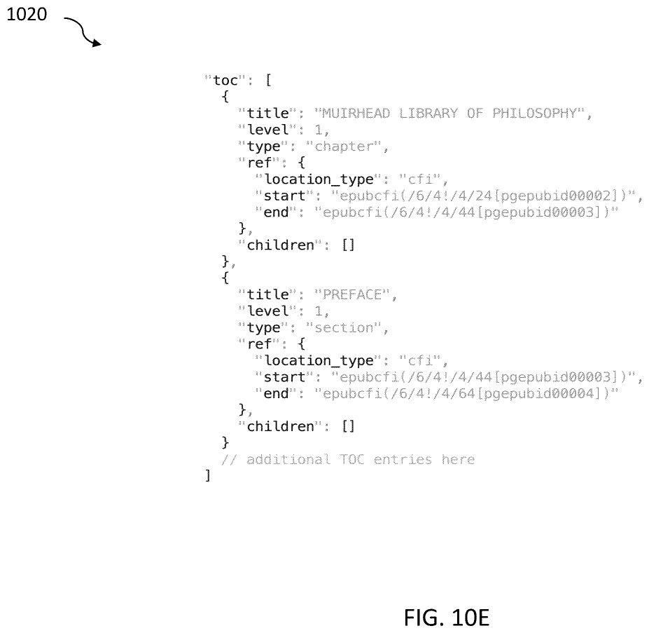

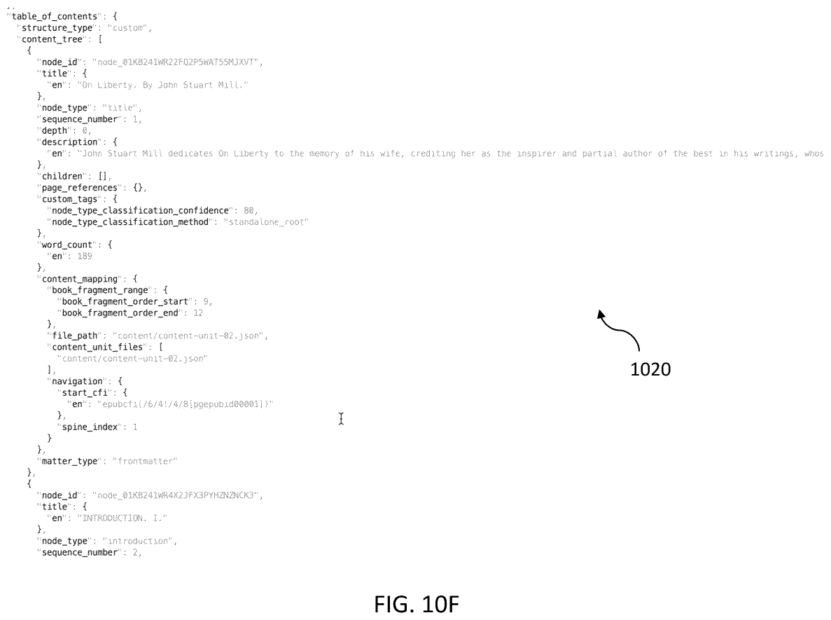

An example of core metadata 1000 is shown in FIGS. 10A-10B. A “content_type” field may indicate a type or modality of the content (e.g., text, video), enabling flexibility, in processing and adaptation. Additional metadata fields, as shown, may capture or include identifiers, classification tags, curated bibliographic information, and/or modality-specific attributes that support downstream AI-driven operations. The fields of the core metadata can be designed to be extensible, allowing the system 150 to incorporate new metadata requirements and/or domain-specific descriptors.

In some cases, the global content descriptor 910 includes transformation metadata. The transformation metadata may include and/or define interaction and derivative capabilities of the content, such as engagement options (e.g., quizzes, annotations, and interactive Q&A) and/or available derivatives (e.g., summaries, translations, and audiobooks). Additionally, the transformation metadata may specify supported languages for derivatives and multimedia adaptation types.

An example of transformation metadata 1010 is shown in FIGS. 10C-10D. The transformation metadata may enable the system 150 to generate tailored derivatives that meet audience needs while preserving the content's contextual and technical integrity. Transformation metadata may also include audience-related information, such as target age group, proficiency level, or domain focus, to support adaptive presentation and personalized content generation. Such metadata elements may be automatically generated or inferred by AI systems when preprocessing content (see operation 720) and/or when transforming content (see operation 730) and may optionally be reviewed or curated by human editors, depending on implementation requirements.

The transformation metadata may also include AI processing metadata, which provides explicit instructions for machine learning models and AI agents to process the content effectively. These features, specified by authors, creators, and publishers, may include preferred models for tasks, such as summarization, translation, and audio generation. The transformation metadata may include task-specific model selections, multimodal processing preferences, and high-level AI notes (e.g., focusing on key arguments, preserving technical accuracy, or applying multi-character narration). Such metadata may be produced through AI-assisted analysis, automated reasoning, or derived heuristics that identify content characteristics requiring special handling. In some cases, human reviewers may supplement or refine these fields when desired, allowing collaborative enrichment of the metadata. The transformation metadata may incorporate reasoning cues, constraint settings, and operational guidelines that inform how AI systems interpret, prioritize, or transform content segments across different generation workflows. Such elements can ensure high-quality and context-aware content transformation while remaining flexible enough to support future AI capabilities, modalities, and derivative formats.

In some cases, the global content descriptor 910 includes a table of contents (TOC). The TOC may outline a hierarchical structure of the content, enabling precise navigation and referencing. Each entry in the TOC may include a title, level, type (e.g., chapter, section), and/or location reference. For location references, the descriptor 910 accommodates multiple formats (e.g., CFI for EPUBs or page numbers for PDFs), making it adaptable across various content types.

An example of a TOC 1020 is shown in FIGS. 10E-10F. The TOC 1020 may include additional metadata fields that support advanced navigation, classification, and AI-driven processing. These fields may include unique node identifiers, multilingual titles, node types, sequence numbers, hierarchical depth indicators, and optional descriptive text. TOC entries may also contain custom tags, confidence scores, or classification metadata derived from AI-assisted preprocessing.

For example, as depicted in FIG. 10F, the TOC 1020 includes nodes that reference underlying content through mappings to content units, file paths, or book-fragment ranges. Navigation metadata (e.g., EPUB CFI locations, page indices, or spine indices) enables precise addressing across different content formats. Additional fields, such as matter type (e.g., frontmatter, bodymatter), word counts, or semantic markers, provide contextual information that can be used by AI systems to reason about structure, improve retrieval accuracy, or support adaptive reading experiences.

Thus, in some examples, the global content descriptor 910 may combine different types and entries of metadata to provide a robust organization and adaptability of content, facilitating advanced AI-driven operations and enabling seamless user interactions. The descriptor 910 provides AI systems with a macro-level map of the content's structure, allowing the AI systems to interpret, reference, and navigate content efficiently across modalities. The descriptor 910 may incorporate both basic and enriched representations of the TOCs, to support hierarchical navigation, semantic understanding, and precise location mapping. Elements of the global content descriptor 910 allow AI systems to respond accurately to user queries, such as locating specific sections, generating summaries for selected portions, or adapting content to specific use cases and formats.

In some examples, as described herein, the AI-ready content format 900 may include different components, such as metadata, content structure, and AI-specific directives. AI/ML frameworks and/or systems may leverage the components when interacting with the content in its AI-ready content format 900, versus other static formats (e.g., EPUB).

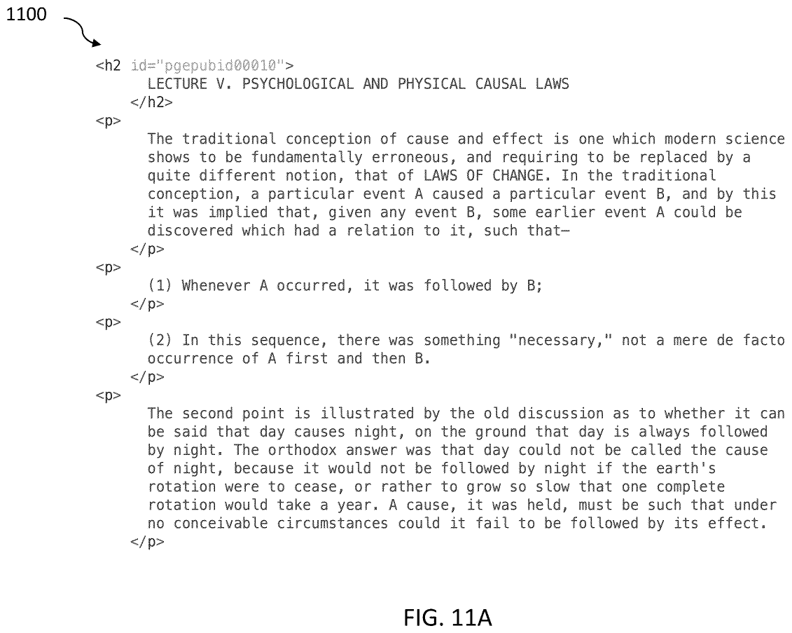

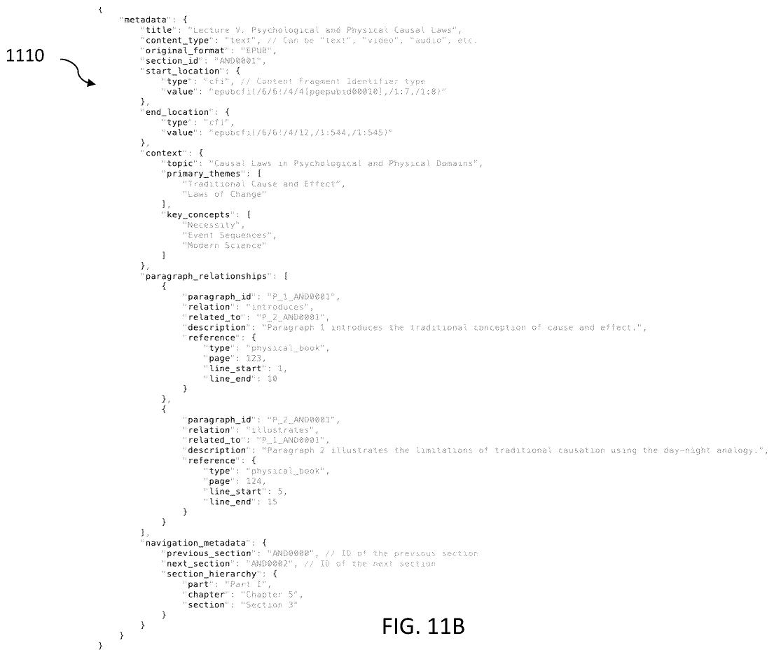

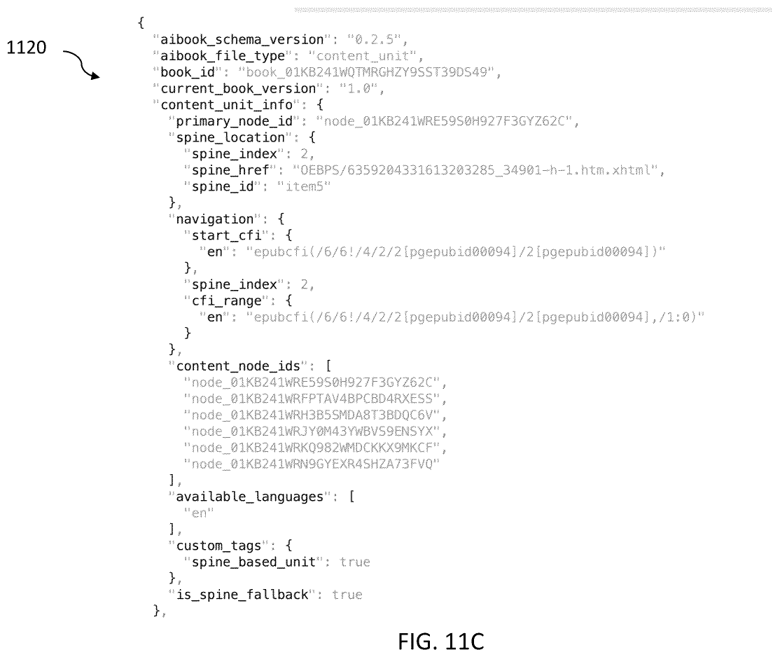

As an example, FIG. 11A depicts a sample chunk of content in a EPUB format (e.g., a section from “The Analysis of Mind” by Bertrand Russell). As described herein, EPUB files lack a robust mechanism for tracking the precise location of individual paragraphs or sections, which makes it challenging to maintain references or mappings during AI processing. Furthermore, the absence of explicit contextual metadata prevents AI agents from effectively understanding the relationships between sections, paragraphs, or themes within the document or text. These relationships, as leveraged by different AI agents (e.g., experience generation agents 540, interactive agents 630, and so on), facilitate the production of coherent, accurate, and contextually aligned outputs (e.g., generated content).

Further, EPUB formats do not provide embedded instructions for tasks, such as translations of specific parts of content or generating derivative works (e.g., summaries, annotations, or adaptations.) AI systems, therefore, cannot utilize such formatted content, as the content does not include structured and semantically rich data to produce accurate and meaningful outputs. Thus, via the chunk descriptors 920 described herein, the system 150 may introduce explicit metadata, contextual relationships, and/or AI-oriented directives that are not available in traditional content formats.

An example of metadata 1110 for the chunk descriptor 920 (within the transformed content) is shown in FIG. 11B. The metadata 1110, or metadata section or component, serves as a structured and semantically rich layer that provides contextual, thematic, and navigational information for the associated content. Each piece of transformed content may include metadata fields, such as title, section identifiers, primary themes, key concepts, and contextual relationships (e.g., paragraph_relationships). Some metadata fields, such as titles and section identifiers, may be generated by parsing the source content. However, other fields (e.g., a paragraph_relationships field) can be automatically generated by the system 150 using ML models that infer semantic, logical, or rhetorical relationships between paragraphs to enhance the contextual integrity of the content.

In some cases, the metadata fields enable precise identification and localization of content elements, supporting seamless referencing, navigation, and interaction across different system components. Additionally, the metadata 1110 empowers or supports enhanced AI-driven operations, such as generating tailored responses to specific user queries about content pages or paragraphs, thereby significantly improving adaptability and user engagement capabilities.

In some cases, paragraph relationships may enhance the functionality of AI-driven systems for processing and transforming content. Such relationships explicitly define the semantic and logical connections between paragraphs (e.g., “introduces,” “illustrates,” or “expands,”) allowing AI systems to preserve the contextual flow and coherence of the content. By incorporating paragraph relationships into the metadata, the system 150 enables efficient chunking of content for operations such as translation, summarization, and annotation. For example, when a paragraph in a text introduces a concept and another expands or illustrates the concept, the paragraph relationships field can track and ensure that the associated sections are processed together, maintaining the logical structure and/or preserving the original intent.

Further, in some cases, the metadata 1110 may include a reference key within paragraph metadata, which links each paragraph to its corresponding location in a physical or alternative source format. The reference key may contain sub-fields, such as type, specifying the reference type (e.g., physical_book), and specific details like page, line_start, and line_end. The reference key enables the AI systems to connect digital and physical content, supporting hybrid experiences, such as discussing specific sections in a printed book or explaining figures and diagrams based on their physical location, guiding users to the exact page or line in a physical copy during a study session, synchronizing digital highlights with page-based references, and/or enabling readers to move seamlessly between digital annotations and their corresponding locations in the printed edition. Thus, reference keys can facilitate integration between formats, allowing users to combine the benefits of digital tools with the familiarity of traditional reading materials.

For example, within translation workflows, paragraph relationships improve accuracy by grouping semantically connected paragraphs, allowing the system 150 to maintain continuity and avoid disjointed outputs. In doing so, the system 150 may generate derivatives, such as multilingual translations, where logical connections between paragraphs are to be preserved across languages. Additionally, the use of paragraph relationships may support the creation of derivative works (e.g., summaries or interactive educational modules) by guiding AI agents to identify relevant sections for inclusion, ensuring that key concepts, explanations, and examples remain contextually aligned and thematically coherent.

Another example of metadata 1120 for the chunk descriptor 920 (within the transformed content) is shown in FIG. 11C. The metadata 1120 includes structural and navigational attributes that describe how a given content unit (e.g., a chunk or sub-chunk) is positioned within a broader work or text. The metadata 1120 may include metadata fields, such as the schema version, file type, and book identifiers, which enable consistent interpretation of the content unit across different system components.

For example, a content_unit_info section of the metadata 1120 may specify primary_node_id, which corresponds to an entry in the TOC, and identifies the node that conceptually anchors this content unit within the global structure of the book. When the source document is an EPUB file, the metadata 1120 also includes detailed EPUB-specific information, such as the spine index, spine href, and spine identifier, allowing the system 150 to preserve the original ordering and structural mapping defined by the EPUB spine.

Navigation metadata, in some cases, may enhance the alignment by defining precise content fragment identifiers (CFIs), including the start CFI and CFI ranges, enabling accurate mapping back to specific portions of the EPUB file. Thus, AI agents may reference, retrieve, or regenerate content segments with high positional precision, ensuring consistency across transformations.

In some cases, the content_node_ids list enumerates all nodes associated with the content unit, each corresponding to TOC elements or hierarchical components of the content. The list may support a structured traversal and reconstruction of a document's logical organization. Language availability, custom tags (e.g., flags indicating whether the unit is derived directly from the spine), and/or fields like is_spine_fallback may guide or facilitate the interpreting or recovering of content under varying processing conditions.

Thus, the metadata fields of the metadata 1110, 1120 enables AI systems to accurately map, reference, and contextualize content units. By explicitly linking each content unit to its TOC node and preserving EPUB-specific structural information, such as spine position and CFIs, the system 150 may support interoperability between the transformed content and the original EPUB source document, enabling various operations, such as location-based queries, synchronized reading, hybrid digital-physical navigation, and multimodal derivative generation.

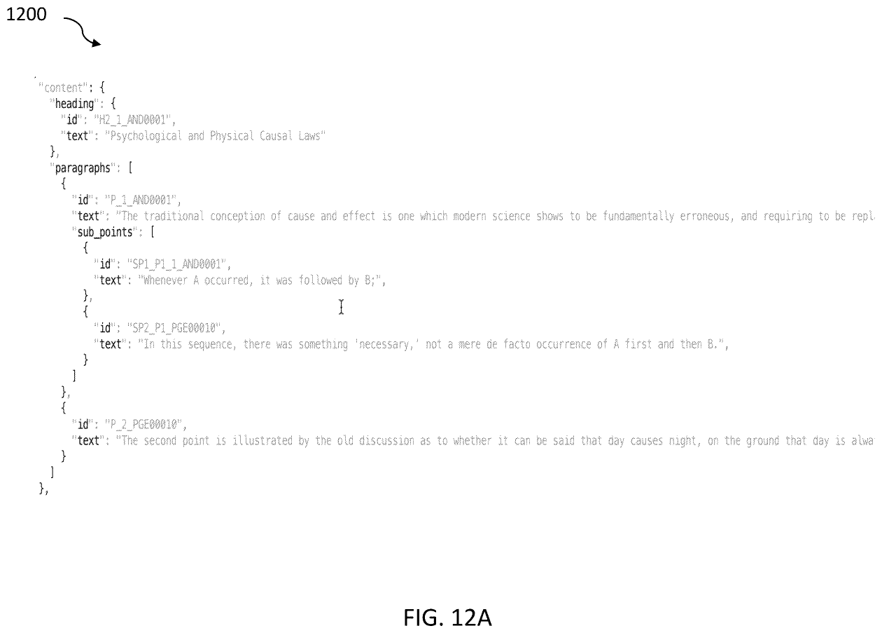

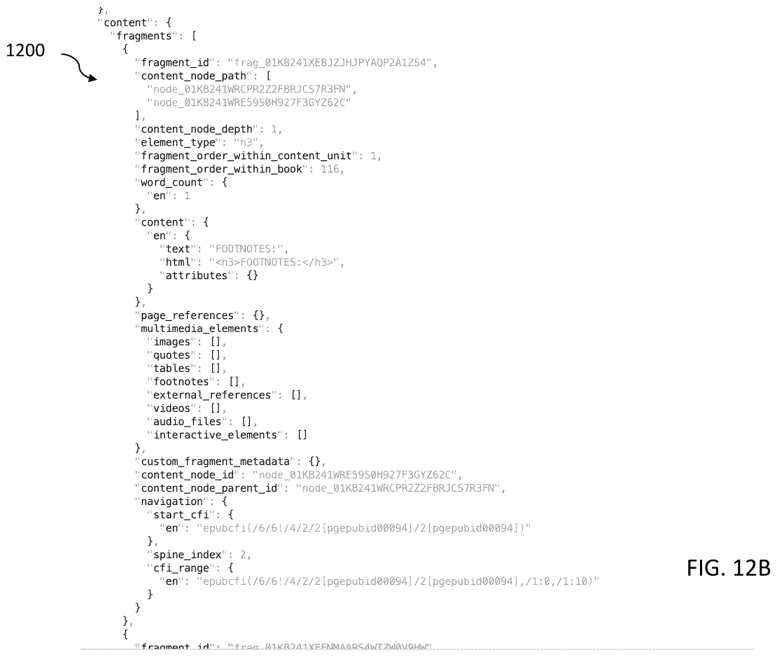

An example content section 1200 of the chunk descriptor 920 (within the transformed content) is shown in FIG. 12A. The content section 1200 may be formed of hierarchical elements, including headings, paragraphs, and sub-points, each assigned a unique identifier to ensure accurate referencing. Each paragraph of a work or text, represented as a distinct entry, contains its unique identifier and text body, enabling a main narrative or argument can be independently addressed, processed, or referenced. In some cases, the content hierarchy mirrors the logical structure of the source material, allowing AI systems to preserve argumentative flow and conceptual dependencies when performing downstream operations. Additionally, paragraphs can include sub-points, which further break down the content into granular elements, such as enumerations or lists, each with its unique identifier and text. These sub-points enable fine-grained semantic segmentation, enabling different AI agents (e.g., experience generation agents 540, interactive agents 630, and so on) to reference, interpret, or transform individual ideas or logical steps with a high degree of precision or fidelity.

FIG. 12B depicts additional information within the content section 1200. The additional information may include information that dictates how individual fragments of content are represented, organized, and enriched with structural details. For example, the content may be divided into fragments, where each fragment is assigned a unique fragment_id to ensure precise referencing and independent processing. Each fragment may correspond to an HTML element extracted from XHTML files of the EPUB source, and includes a content_node_path that identifies the TOC nodes and hierarchical elements associated with that fragment, thereby anchoring the fragment within the broader logical structure of the work.

A fragment may include detailed metadata, such as content_node_depth, element_type (e.g., h3), fragment_order_within_content_unit, and fragment_order_within_book, allowing AI systems to reconstruct the original ordering and ensure that fragments are processed in a semantically coherent sequence. Word-count fields may further support downstream tasks such as summarization, readability analysis, or adaptive compression.

The content section 1200 (or block) may store the textual or markup representation of the fragment. For example, both plain text and HTML versions are provided, along with optional attributes, which may encode stylistic or semantic cues. The dual representation supports multimodal processing and ensures compatibility with various rendering, generation, or analysis pipelines. Further, fragments may include additional fields, such as page_references, multimedia_elements (e.g., images, quotes, tables, footnotes, external references, videos, audio files), and interactive_elements (not shown). Such structures allow the system 150 to attach multimodal or interactive assets to any fragment, enabling richer derivative generation and enhanced user experiences.

In some cases, the fragment metadata also includes content_node_id and content_node_parent_id, which explicitly define hierarchical relationships between content nodes. These relationships enable AI systems to understand nesting structure and process fragments with appropriate context. Further, a fragment may include detailed navigation metadata, such as start CFI, spine index, and CFI range, linking each fragment back to its precise position within an associated EPUB source. Because the fragments originate directly from XHTML elements, the navigation references maintain a strong and accurate mapping between the transformed representation and the underlying EPUB document.

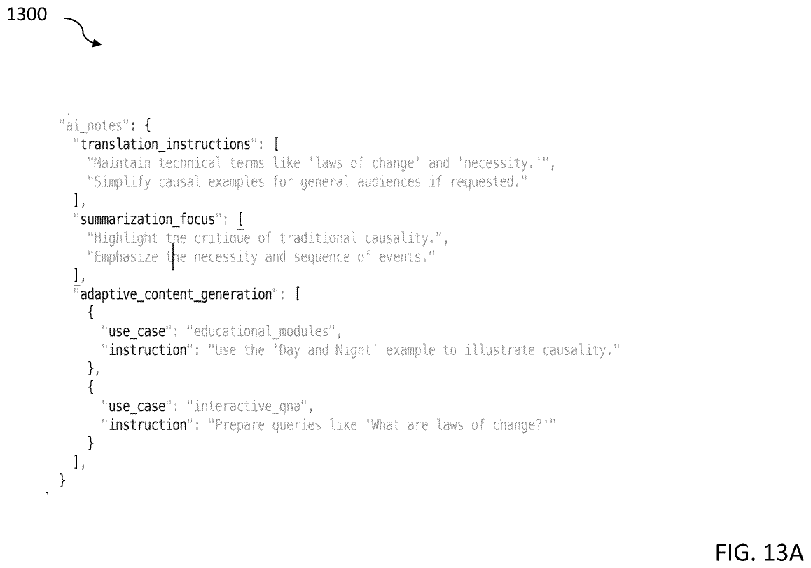

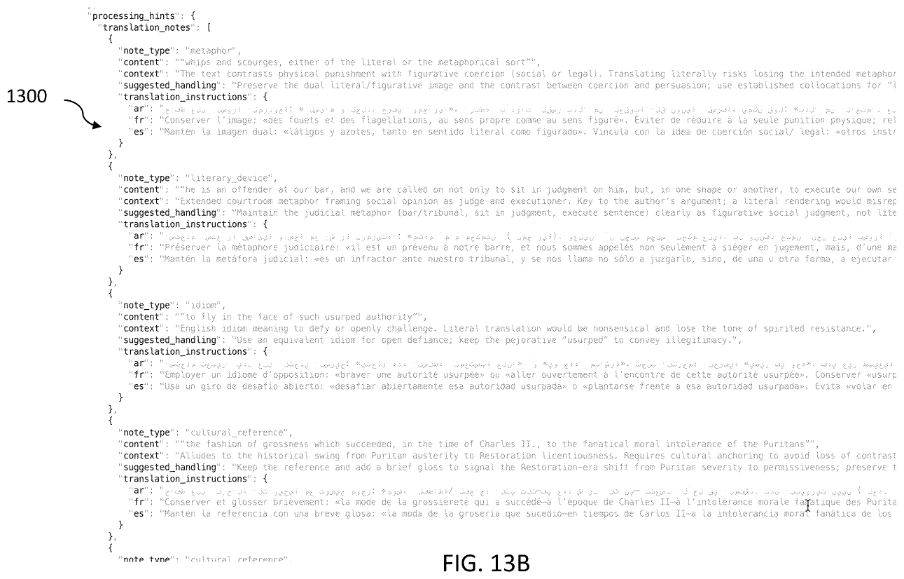

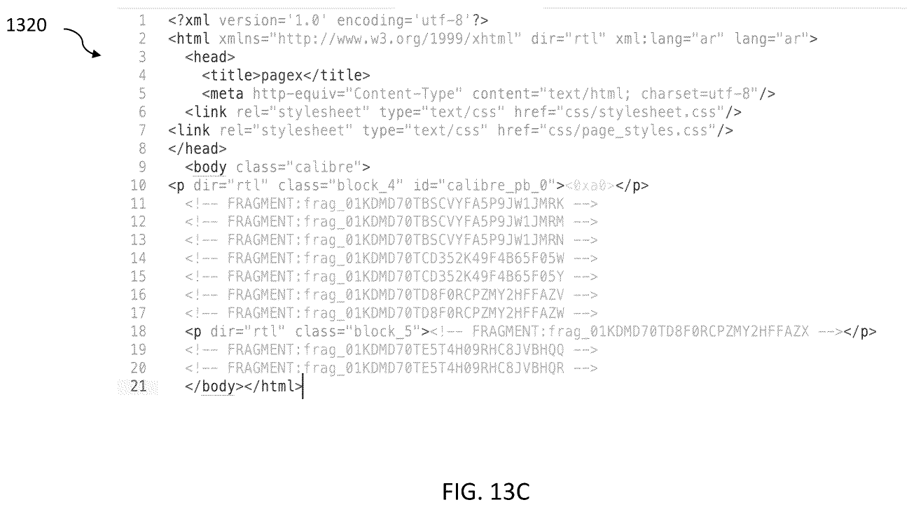

An example AI notes section 1300 of the chunk descriptor 920 (within the transformed content) is shown in FIG. 13A. For example, the AI notes section 1300 may provide explicit instructions and guidelines tailored for ML systems, including AI agents, enabling them to generate, translate, or adapt content to suit various use cases and audience requirements. The metadata within the section 1300 may act as a directive layer, ensuring that the operations performed by the interactive and experience generation agents align with specific user goals, contextual nuances, and quality standards. The AI Notes section 1300 may be generated dynamically by AI systems during preprocessing or transformation or may be specified directly by authors, editors, or publishers, depending on implementation requirements. Thus, the metadata within the AI notes section 1300 can enhance adaptability by encoding contextual preferences and operational constraints that guide downstream processing.

In some cases, the section 1300 may include a translation_instructions field that guides translation AI agents in preserving the technical accuracy of terms such as “laws of change” or “necessity,” while dynamically adjusting the level of complexity for non-technical audiences. Similarly, a summarization_focus field may provide directives for summarization AI agents, highlighting key themes (e.g., a critique of traditional causality) or emphasizing the necessity and sequence of events to maintain relevance and fidelity to the source material.

Further, an adaptive_content_generation field may enhance flexibility by including use-case-specific instructions, such as creating educational modules using illustrative examples like “Day and Night” or preparing interactive Q&A experiences with queries like “What are laws of change?” These instructions enable the system 150 to generate tailored, engaging, consistent and purpose-specific derivative experiences, ensuring that content transformation remains context-aware and aligned with user intent across multiple modalities.

FIG. 13B depicts additional fields within the metadata of the AI notes section 1300. For example, a processing_hints field may provide a granular and linguistically focused set of directives that assist AI systems, such as translation AI agents and adaptive content generation AI agents, in handling nuanced textual elements, such as metaphors, idioms, literary devices, and cultural references. These hints may act as fine-grained guidance that supplements general translation or summarization instructions, enabling the system to maintain semantic fidelity, stylistic intent, and contextual relevance across languages and modalities.

For example, each entry within the processing_hints metadata may include structured fields such as note_type, content, context, and suggested_handling, which together describe the linguistic phenomenon, explain its role within the source material, and propose strategies for accurate adaptation. For example, the hints may include information or instructions for addressing metaphors (“whips and scourges”), literary framing devices (courtroom metaphors), idioms (“to fly in the face of”), and cultural references (historical shifts from Puritan to Restoration norms). Such descriptions enable AI agents to distinguish between literal and figurative meaning, recognize idiomatic expressions, and preserve culturally significant nuances that would otherwise be lost in direct machine translation.

In some cases, a translation_instructions field provides multilingual guidance, such as in Arabic, French, and Spanish, demonstrating how an AI agent may render the phrase appropriately in each target language. The field may assist the system 150 to choose equivalents that maintain the rhetorical effect, emotional tone, or cultural anchoring of the original text. In some cases, the multilingual mappings may be generated automatically by AI models trained on translation patterns or curated by human experts, depending on the implementation.

Thus, in some examples, the AI notes section 1300 may include a metadata layer that provides high-resolution contextual cues to assist in translation, summarization. Adaptation AI agents may thus avoid common pitfalls such as literal mistranslation, loss of figurative meaning, or erasure of culturally embedded references. By encoding these processing hints at the fragment or paragraph level, the system 150 ensures that derivative outputs, whether translations, summaries, or instructional content, retain the conceptual accuracy, stylistic nuance, and cultural appropriateness of the original work.

In some examples, the use of discrete content fragments and corresponding fragment identifiers enables the system 150 to reproduce, assemble, and render the underlying work in multiple output formats by selecting and combining fragments according to a target representation. This fragment-based approach applies segmentation by partitioning the work into modular, addressable units that can be independently stored, retrieved, and recomposed. In some examples, a fragment identifier serves as a stable reference point for associating auxiliary assets, such as illustrative figures, annotations, interactive elements, or animations, with a specific portion of the work, such that the auxiliary assets may be inserted, overlaid, synchronized, or otherwise presented in connection with the referenced fragment during playback, display, or generation of a derivative output.

Further, the fragment-based representation allows fragments to be processed individually or in groups using any suitable processing logic (e.g., automated software routines and AI agents) to perform transformations, enrichment, re-ordering, filtering, or other operations, and to recombine the processed fragments into one or more derived works, editions, or presentations as required by the executing software, the output format, or user-specified constraints. FIG. 13C depicts an example fragment aggregation 1320 for reconstructing an HTML page, in which multiple fragment identifiers are ordered and composed to render the page content, with optional styling applied independently of the fragment payload.

In some cases, the fragments may be aggregated to construct a target representation of the work in a structured format. As shown in FIG. 13C, multiple fragments (each referenced by a respective fragment identifier) may be assembled to form an HTML page by arranging the fragments in a specified order and/or hierarchy. The resulting page may be reconstructed by a rendering component by resolving the referenced fragments and composing their content into a single document object model (DOM) or equivalent representation. In some cases, the same underlying fragments may be reused to generate multiple HTML pages or views, while allowing optional styling (e.g., via templates, style sheets, presentation rules, or other formatting directives) to vary the visual presentation of substantially identical content without altering the fragment payload itself.

### Examples of an Agent Translation Workflow

As described herein, the content experience system 150 may utilize AI agents to transform content, generate derivative works, and deliver interactive experiences. The AI agents may be specialized, intelligent software entities powered by multimodal large models (MLMs) or other advanced AI architectures, capable of processing and reasoning across diverse data modalities, including text, images, audio, and video. AI agents may invoke tools, such as modular components that perform well-defined, task-specific operations. The tools may include search utilities, dictionaries, content retrieval mechanisms, timeline and visualization generators, media processing components, evaluation modules, or other subordinate AI agents functioning as specialized tools. By integrating these tools, AI agents can dynamically adapt to the requirements of their assigned tasks, ensuring precision, context-awareness, and efficiency in their operations.

AI agents may be equipped with memory components to store contextual information about the tasks they perform or the users they interact with. This contextual information can originate from previous experiences, such as earlier tasks or feedback, or from interactions with users, such as expressed preferences or customized instructions. By leveraging memory efficiently, AI agents can achieve a better understanding of the tasks they are working on, allowing them to learn from mistakes and improve over time. For interactive AI agents, memory enables the system 150 to adapt to user preferences, delivering a more personalized and seamless experience. Thus, the dynamic integration of memory ensures that AI agents are continually evolving, enhancing their ability to deliver accurate, user-centric, and contextually relevant outputs.

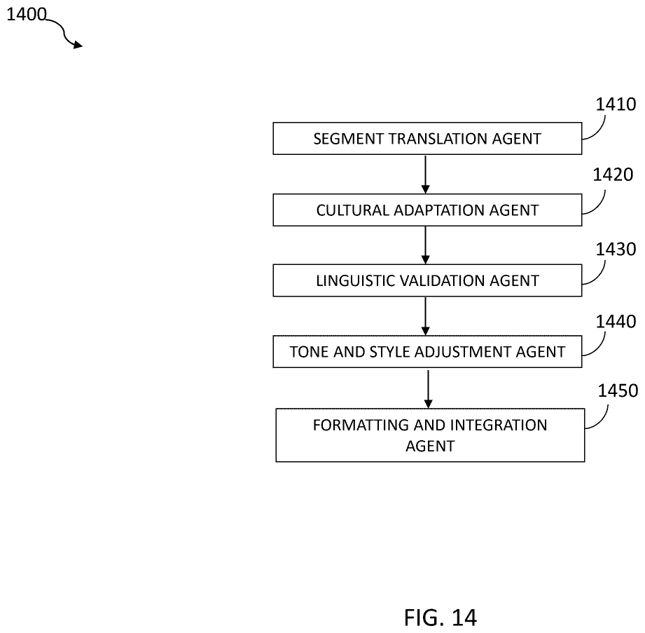

FIG. 14 depicts an example setup 1400 of AI agents. The setup 1400 may be deployed for a translation workflow, such as when translating content from one language to another. The AI agents may include experience generation agents 540 within the multimodal content module 250. As described herein, these agents 540 may include specialized capabilities that leverage advanced multimodal processing techniques, contextual metadata, and integrated tools to deliver high-quality translations while preserving the original content's meaning, tone, and intent.

The setup 1400 may be configured as a sequential collaboration of multiple specialized AI gents, each performing distinct roles to ensure a high-quality, contextually aware translation.

First, a segment translation agent 1410 converts individual content segments (e.g., chunks), from a source language to a target language. The content may be represented in the AI-ready content format 900. The segment translation agent 1410 may leverage MLMs and contextual metadata to ensure linguistic accuracy while preserving the intent and tone of the original text.

A cultural adaptation agent 1420 receives the converted chunks and modifies idiomatic expressions, metaphors, and culturally specific references to align with the cultural norms of the target audience or language. Thus, the agent 1420 performs tasks to preserve meaning while ensuring cultural appropriateness, making the translation intelligible, natural, and relevant within the target audience's linguistic and cultural context.

A linguistic validation agent 1430 performs rigorous quality checks on the translated text. The linguistic validation agent 1430 may check for grammatical accuracy, syntactical correctness, and semantic fidelity, preserving the original meaning while enhancing the readability and fluency of the translation. By leveraging certain linguistic models, the agent 1430 identifies and resolves any inconsistencies or errors in the translated content, improving internal coherence and eliminating mistranslations, ambiguous phrasing, and/or structural errors.

A tone and style agent 1440, following the validation of the translations, may refine the translation further by aligning it with predefined tone and style requirements. Whether the content demands a formal academic tone or a casual conversational style, the agent 1440 ensures that the translation adheres to the desired stylistic guidelines, providing a consistent and professional output. The agent 1440 may apply domain-specific stylistic conventions, such as legal, educational, or narrative styles, depending on the use case or scenario.

Using the refined translation as an input, a formatting and integration agent 1450 reintegrates the translated content into an original document structure. The agent 1450 may determine that headers, subheaders, and other structural elements are correctly formatted, and that visual elements, such as images or tables, are appropriately aligned with the translated text. By utilizing the AI-ready content format 900, the agent 1450 verifies the final output is ready for downstream applications, including derivative generation and distribution across multiple platforms, ensuring structural fidelity, format consistency, and compatibility with both interactive modules and automated generation workflows, among other benefits.

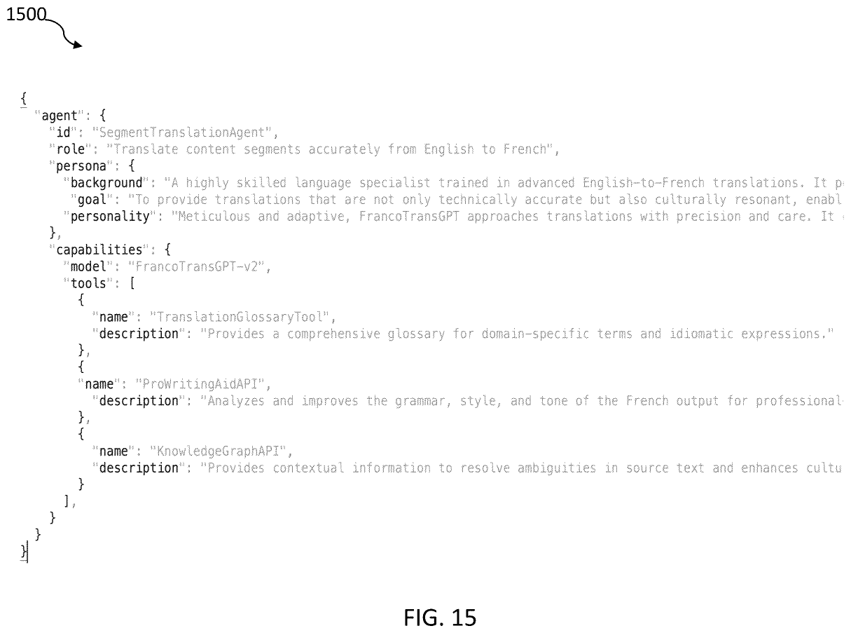

FIG. 15 depicts an example AI agent 1500. The AI agent 1500, represented as a JSON file, includes information detailing its role, persona, capabilities, and integrated tools. The structured definition may serve as a comprehensive prompt for the underlying MLMs, guiding them to operate effectively within their assigned context. For instance, the AI agent 1550 may be a “SegmentTranslationAgent” that is designed to translate content segments from English to French with accuracy and cultural sensitivity, and the JSON description ensures (e.g., includes information) that the MLM understands the task's nuances, such as linguistic precision and contextual relevance. By encoding these operational parameters in machine-readable form, the description of the AI agent 1550 establishes predictable behaviors and consistent processing standards across executions.

The JSON file also includes persona attributes, such as background, goal, and personality, that act as guiding principles for the MLM. These attributes shape how the MLM approaches tasks, ensuring outputs align with the desired tone, style, and user expectations. In some cases, persona attributes also help enforce domain-specific behavior (e.g., academic rigor, formal tone, or child-friendly language) that the AI agent 1500 maintains throughout a workflow. In some cases, the integration of specialized tools, like the TranslationGlossaryTool and ProWritingAidAPI, extends the MLM's capabilities by providing auxiliary functionalities that complement its core processing power. These tools may support terminology resolution, linguistic refinement, cultural adaptation, contextual lookup, or other advanced operations that require external resources or algorithmic subsystems. This combination of structured metadata and external tools equips the AI agent 1500 to dynamically adapt to specific requirements, delivering outputs that are both contextually aware and technically precise.

In some examples, the AI agents may leverage contextual information provided by the AI-ready content format 900, which includes metadata, structure, and relationships critical to maintaining the integrity of the translated content. Additionally, AI agents can access other context-rich data (e.g., data stored the content-specific memory 505 and/or the experience-specific memory 510), allowing AI agents enhance their task understanding, adapt to user preferences, and maintain continuity across operations. By combining these contextual sources, AI agents can interpret content with greater accuracy, preserve semantic relationships across segments, and produce outputs that remain consistent with prior decisions made earlier in the pipeline.

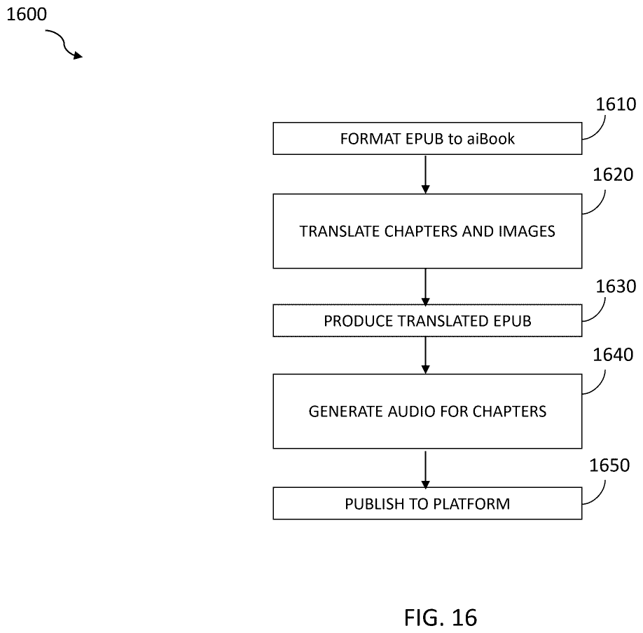

FIG. 16 depicts a workflow 1600 for converting an EPUB into an aiBook (e.g., an intermediate representation) and, for each supported language, generating translated electronic-book outputs (including translation of textual and image-embedded content) and corresponding audiobook audio segments for publication to a platform. As described herein, content in an aiBook format may include some or all components of the AI-ready content format 900, and may enable downstream generation of multiple derivatives, including translated editions and audiobooks corresponding to those translations.

At operation 1610, the content experience system 150 converts a source text (e.g., a book) into an aiBook format (described herein). In operation 1620, the content experience system 150, translates chapters and/or images of the source text. For example, the multimodal content module 250, executes a language-specific translation pipeline that is repeated for each supported target language.

Within each target language pipeline, the book may be processed in segments (e.g., by chapter, section, fragment, or other logical unit), such that text translation for each segment (e.g., “Translation of Chapter 1,” “Translation of Chapter 2,” “Translation of Chapter 3”) can be performed independently and/or in parallel. In addition to translating textual content, the system 150 may perform image translation (e.g., translating embedded captions, labels, callouts, or other text rendered within images) for the target language, thereby preserving semantic consistency between textual and graphical components of the work.

At operation 1630, the content experience system 150 produces translated EPUB outputs (or other publication-ready formats) reflecting the translated text and translated image content. In some cases, the production of the EPUB format may benefit from the fragment aggregation approach discussed herein.

At operation 1640, the content experience system 150 generates audio renditions for each translated edition. The system 150 may perform audio generation on a per-segment basis (e.g., “Audio generation of Chapter 1,” “Audio generation of Chapter 2,” “Audio generation of Chapter 3”), allowing the system 150 to synthesize spoken content for the translated text and assemble the resulting audio segments into an audiobook or other audio-enabled representation.

At operation 1650, the content experience system 150 publishes the generated outputs to a platform, which may include storing and indexing the translated e-books and corresponding audiobooks, and making them available for distribution, playback, rendering, or further derivative generation. For example, the AI-ready content format 900 may operate as a common intermediate representation that supports repeatable, multi-language content generation workflows, including both translation and audio production, with segmentation enabling modular processing and recomposition.

### Examples Scenarios Supported by the Context Experience System

In a first scenario, a user is an interactive reader. For example, Bob is a university student preparing for an exam using a textbook on cognitive psychology. Bob often studies while multitasking, such as taking notes or organizing study materials. He needs a reading assistant that can adapt to his workflow, answer his questions in real-time, and help him engage with the material without needing to navigate the textbook manually.

Via the content experience system 150, Bob accesses an interactive reader via his mobile device. He begins by saying, “Start reading from Chapter 3, Section 2.” Because the content is represented or structed in the AI-ready content format, the interactive reader localizes the location and start narrating the specified section of the textbook in a clear, human-like voice.

Before starting his session, Bob receives personalized recommendations through the system 150. Based on his study history and upcoming exam topics, the system 150 suggests starting with Chapter 3, “Memory and Cognition,” highlighting key sections such as “Episodic Memory” and “Neural Pathways of Retention” as useful reading. The system 150 also offers a short overview of the chapter's content and suggests additional resources, such as a summary of related chapters or a brief video explaining foundational concepts.

During narration of the content, Bob interrupts, saying, “Wait, can you explain what episodic memory means?” The system 150 pauses and provides a concise explanation: “Episodic memory refers to the ability to recall specific events or experiences from your past, like remembering your first day at school.” It further suggests, “Would you like an example or a deeper explanation?” As described herein, the system 150 answers questions using content from the book as well as external sources, while ensuring accurate citation of all information sources.

Throughout the session, Bob takes notes on key concepts. For example, after learning about episodic memory, he says, “Add this explanation to my notes.” The system 150, via a note-taking tool (e.g., an agent tool 525) automatically creates a note titled “Episodic Memory,” storing the definition, key differences with semantic memory, and relevant examples in an organized format. Bob can later access, edit, or share these notes through the module's integrated tools. When Bob asks, “Can you summarize my notes from this chapter?”, the system 150 compiles a concise summary of all saved notes from Chapter 3, providing him with a quick revision tool tailored to his study needs.

Later, Bob asks, “Can you skip to the summary of Chapter 3?” The system 150, with access to the AI-ready content format 900, seamlessly navigates to the chapter summary and begins reading. Bob then inquires, “What are the key differences between episodic and semantic memory?” The reader compares the two concepts, highlighting differences in an easy-to-understand format while referencing relevant sections of the textbook.

Bob engages further, asking, “What are some practical applications of episodic memory research?” The system 150 dynamically pulls insights from the book, presenting them in a structured answer. It also asks, “Would you like me to bookmark this question for revision later?

After completing his session, Bob accesses a post-reading insights feature, which provides a summary of his activity. The system 150 highlights key concepts he interacted with, such as “Episodic Memory” and “Neural Pathways,” and generates a personalized quiz to reinforce his understanding. Additionally, it suggests follow-up actions, like reviewing notes from previous sessions, revisiting challenging sections, or exploring supplementary materials such as related articles or short videos. The system 150 also tracks Bob's performance and progress, offering tailored recommendations for his next study session.

Thus, using the interactive reader provided by the content experience system 150, Bob has an engaging and hands-free study experience. He navigates content efficiently, accesses contextual explanations on-demand, and reinforces his understanding of critical concepts, all through voice interaction. The interactive reader transforms studying into a dynamic and interactive process, enhancing Bob's comprehension and retention of the material.

In a second scenario, a user does some interactive reading. Daniel is a busy professional who is reading a non-fiction book (e.g., a self-help book) to improve his daily routines. He prefers the depth of a traditional book but also wants real-time support, such as support for answering questions, generating summaries, creating audio versions, or capturing voice notes. Daniel connects with the system 150 via his laptop and accesses an enhanced, interactive version of the book.

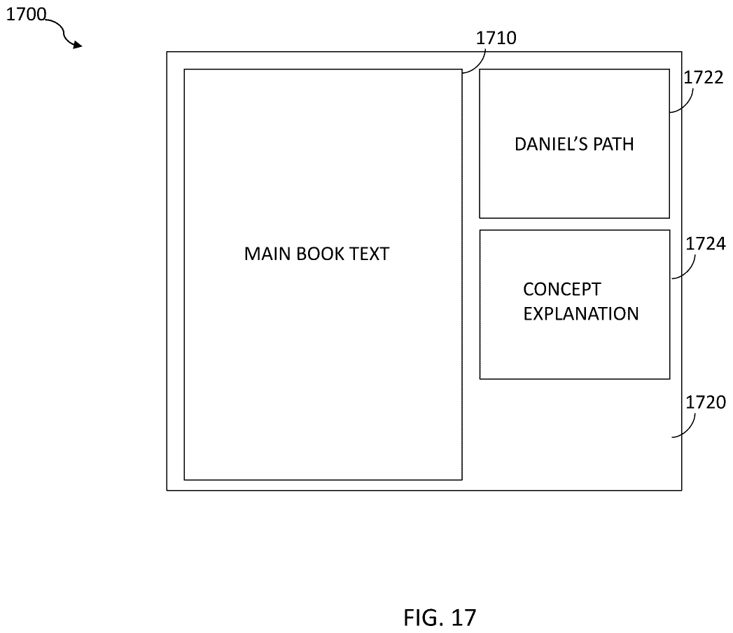

When Daniel opens the book, the system 150 loads a personalized landing page rather than starting at the first chapter. FIG. 17 depicts an example user interface (UI) 1700 of an interactive book. The UI 1700 may include two coordinated panels, a reading view 1710 and a personalized experiences view 1720.

The reading view 1710 (e.g., a left panel) may display a main book text with clean navigation, search, and annotation controls. The view 1710 may not change as Daniel switches between experiences. The personalized experiences view 1720 may be customized dashboard generated from the AI-ready content format 900 of the source book and user specific data for Daniel. The view 1720 may include various different widgets, UIs, or interactive elements described herein, including a choose-your-own reading path assistant 1722 and an assistance UI 1724 (e.g., for concept explanation). The view may open, render, and/or swap experiences at any time without interrupting the primary reading flow within the reading view 1710.

Throughout his reading session, Daniel relies on the conversational assistance provided by the system 150. At any moment, he can click the assistant icon or speak naturally into his laptop microphone. For example, while reading a section about habit stacking, Daniel pauses and asks: “What does habit stacking mean in simple terms?” An AI agent (e.g., the interactive agent 630) instantly responds in the right panel (e.g., view 1720): “Habit stacking means attaching a new behavior to an existing habit, so the existing habit becomes a cue for the new one.”

Daniel then asks: “Give me two examples based on my morning routine.” The AI agent responds with tailored examples derived from his stored morning habits (e.g., in his user-specific data store). When Daniel encounters a concept to revisit later, he says: “Bookmark this explanation in my Habit Notes.” The AI agent stores the explanation and links it to the exact fragment in the AI-ready content format 900 for future retrieval.

Daniel selects a “Choose Your Reading Path” option in the view 1720, where the an AI agent uses his user-specific data to generate multiple personalized reading paths instead of a single fixed sequence. Each path is a dynamic route through the book, optimized for different combinations of Daniel's goals, learning preferences, and available time. For example, based on his interests, the AI agent presents several options, including: (1) a motivation path that starts with a motivational micro-story, then moves into core concepts such as identity-based habits and habit stacking, and ends with brief reflections; (2) a core concepts path that prioritizes foundational ideas and key frameworks; and (3) a practice path that emphasizes exercises and targeted reflections.

Daniel can select the path that best matches how he wants to experience the book and can switch paths at any time, with the AI agent continuously adapting the sequence to his ongoing engagement and preferences.

While reading, Daniel decides he wants a concise version of the most important ideas. He clicks the assistant icon and says: “Create a short sub-book summarizing the key ideas from Chapters 1 and 2, focusing on small habits and identity.” The interactive agent 630 generates a sub-book that contains condensed explanations, bullet points, and example stories. Also, a tab called “Summary Sub-book” appears in the left panel and displays the sub-book.

Later, Daniel wants exercises to internalize the material. He asks “Generate a workbook with 5 reflection questions and 3 practical exercises for each of the first three chapters. The system 150 creates a workbook and quizzes experience. The system 150 then displays the workbook, which Daniel can open to launch a modal presenting interactive questions, including multiple-choice, true/false, and multiple-selection formats.

Daniel also prefers to capture quick thoughts orally. At the end of a reading session he says: “Record a voice clip of the key takeaways from chapter 3.” The system 150 invokes an AI agent to create a voice takeaways audio clip, which Daniel can open and play.

Daniel is bilingual and wants to practice his second language. From the personalized page, he selects “Open in Spanish and Start Audio.” The system 150 presents a translated e-book experience (e.g., generated previously by the experience generation agents 540 using the translation workflow) and/or an Audiobook and Narrated Stories experience aligned with the translated text.

The right panel switches to the Spanish text view at Daniel's current location, while the audio player begins reading the same section aloud. Via the AI-ready content format 900 the system 900 keeps text, audio, and original-language references synchronized via CFIs and fragment identifiers. Daniel may tap any paragraph to jump the audio to that exact sentence, ask, “Switch this paragraph back to English,” causing the AI agent to temporarily show the original text for comparison, say, “Slow the narration and highlight each sentence as it is read,” enabling a language-learning mode, and so on. The UI 1700 may present these experiences appear as separate tabs (e.g., ES Reading View, ES Audiobook) in the left panel, letting Daniel move smoothly between the original and translated versions.

Thus, using the interactive non-fiction experience, Daniel experiences the book not just as a static text, but as a personalized habit-coaching environment. The dual-panel layout (e.g., the UI 1700) presents a stable anchor in the left panel for his profile, notes, and experience tabs and a dynamic right panel that can switch between sub-books, workbooks, voice clips, and audiovisual or other customized experiences. Daniel, via the system 150, enjoys a deeply personalized, multimodal reading journey.

A third example scenario depicts the system 150 performing interactive tutoring. Sarah is a graduate student studying environmental science. She uses a book on climate change that includes dense, data-heavy chapters and scientific concepts. Sarah finds it challenging to grasp some of the material through text alone and prefers a more visual and interactive learning approach. Sarah accesses the system 150 through her laptop, which generates an interactive course (e.g., course-style content) and presents the content to Sarah.

The system 150 offers a course-like structure for the book, dividing chapters into short, digestible educational modules. Each learning module includes a mix of illustrations, narrated explanations, interactive quizzes, and practice exercises. For example, in the module on renewable energy sources, Sarah explores illustrations comparing the efficiency of solar, wind, and hydroelectric power. She then takes a quiz to reinforce her understanding of key metrics like energy output and sustainability. At any point during the module, Sarah can ask an interactive tutor for an example feature. Sarah asks questions, such as, “Why is methane considered a more potent greenhouse gas than carbon dioxide?” The tutor responds with a concise explanation, supported by an illustrative chart comparing their global warming potentials. If Sarah needs further clarification, the interactive tutor offers to pull additional examples or summarize related sections of the book.

The system 150 adapts to Sarah's progress, identifying areas where she struggles and offering additional practice exercises or alternative explanations. For example, if Sarah struggles with understanding thermal radiation, the system 150, using the AI-ready content format, provides a supplementary illustration and an optional exercise focused on that topic.

Using the interactive tutoring module, Sarah transforms her textbook into an engaging, course-like experience. The illustrative figures and animations help her visualize complex concepts, while the educational modules provide a structured and interactive way to learn at her own pace. The tutoring and Q&A features ensure that Sarah can clarify doubts instantly, making her learning process more efficient and enjoyable.

A fourth example scenario presents interactive fiction reading. Emma is a passionate reader of fantasy novels and enjoys exploring intricate storylines, rich character development, and immersive settings. While reading a fantasy novel via the system 150, Emma wants to engage more deeply with the world-building, track character arcs, and visualize key events in the story. Emma accesses an interactive fiction reader, a feature that is powered by the system 150 through her tablet. The system 150 enhances her experience by offering dynamic content interactions tailored to the novel's plot and characters.

While reading a chapter set in a mythical city, Emma taps the “Explore” button on her screen. The system 150 presents a detailed, interactive map of the city, highlighting key locations mentioned in the story. Emma notices a nearby forest on the outskirts of the city and clicks on it. The system 150 reveals a short history of the forest, its significance in the plot, and its connection to the city's lore. Alongside this information, Emma sees an artist's rendering of the forest and its magical creatures, enriching her understanding of the story's world.

As Emma progresses through the novel, the platform tracks character arcs dynamically. For example, after a major plot twist involving the protagonist, the system 150 prompts Emma with an optional character analysis. She taps to explore a timeline of the protagonist's journey (e.g., or other illustrated content), displaying decisions made, relationships built, and key moments of growth. Emma can even ask questions like, “Why did the protagonist betray her mentor?” The system 150 provides an explanation based on the book's content, offering insights into the character's motivations and the story's context.

During an intense battle scene, the system 150 may render and/or offer an optional animation that recreates the battle visually, generated by the AI agents. Emma watches the protagonist defend the city using their magical powers, with each move synchronized to the narrative text. Further, the interactive fiction reader allows Emma to explore “what-if” scenarios, examples of user selected narratives or paths. For example, she can activate an “Alternate Choices” feature to see how the story would change if the protagonist had made a different decision. The feature may generate a short alternate narrative, enabling Emma to explore the story's possibilities without deviating from the original plot.

Thus, using an interactive fiction reader provided by the system 150, Emma enjoys a fully immersive and interactive experience. The ability to explore world-building elements, visualize scenes, and interact with character arcs deepens her engagement and connection with the story. The system 150 transforms her reading journey into a dynamic exploration of the fictional universe.

A fifth example scenario presents a hybrid reading experience of combining print books with virtual, interactive content. Sophia is a graduate student who prefers reading textbooks in their physical form but often finds herself needing additional explanations and interactive features to fully grasp complex topics. She uses the system 150 to enhance her paper book reading experience. As Sophia reads her physical copy of Advanced Biochemistry, she comes across a detailed diagram on page 56 that explains the Krebs cycle. Feeling uncertain about some of the processes depicted, Sophia opens a companion application on her smartphone and says, “Explain the figure on page 56.”

The system 150, leveraging the metadata section of the AI-ready content format 900, identifies the corresponding content in its digital repository. Because the AI-ready content format 900 contains physical-page references, spine indices, CFI ranges, paragraph mappings, and image descriptors, the system 150 can precisely locate the relevant figure despite Sophia using a paper edition. The system 150 then identifies the corresponding content in its digital repository, retrieves the explanation of the figure, breaking it down step-by-step, and provides an interactive walkthrough of the diagram with audio and/or with visual aids, such as highlighting each step of the cycle on her screen.

The AI agent may also overlay augmented-reality annotations when Sophia points her phone's camera at the page, superimposing dynamic labels, arrows, or animations directly on top of the printed diagram. This enhances her ability to associate the physical figure with the underlying biochemical processes without altering her reading workflow.

While reviewing the explanation, Sophia asks, “What role does ATP play in this cycle?” The AI agent pauses the walkthrough and provides a concise explanation of ATP's involvement, citing the exact section of the book for further context. The AI agent uses context from content-specific data and user-specific data to ensure that its response aligns with Sophia's level of expertise, the specific edition of the textbook she is using, and the instructional goals associated with the chapter. It can also infer temporal context, whether ATP's role is being discussed in the catabolic or anabolic pathway sections and adjust the explanation accordingly. The system 150 may also save the question and response in Sophia's notes for later review. The AI agent dynamically adapts its responses using contextual metadata, ensuring the explanation aligns with the figure and text in the paper book.

In addition, the system 150 may use the guardrails component 615 to ensure the scientific explanation maintains accuracy and avoids introducing misleading analogies or incorrect biochemical interpretations.

Later, Sophia wants a deeper understanding of the topic. She says, “Show me related videos about the Krebs cycle.” The AI agent accesses supplementary multimedia content linked to the book's metadata, providing Sophia with curated video explanations and animations that elaborate on the biochemical processes. These supplementary materials may come from publisher-provided resources, verified open educational databases, or system-generated visualizations created by the experience generation agents 540. In some variations, the system 150 may also recommend interactive problem sets, quizzes, or concept maps derived from chunk descriptors 920 to reinforce Sophia's learning objectives. These materials enhance her comprehension without requiring her to deviate from her preferred reading method.

By integrating the physical reading experience with the platform's interactive features, Sophia can enjoy the tactile and immersive nature of reading a paper book while benefiting from the AI-powered enhancements. The system 150 combines traditional and digital mediums, making learning more engaging, accessible, and adaptable to Sophia's unique preferences.

A sixth example scenario presents a shared reading and discussion experience. Alex is an avid reader who enjoys sharing books with his father, David, as part of their regular bonding activity. Recently, Alex's friend Sarah, who shares his interest in history, expressed a desire to join their discussions. Alex introduces both David and Sarah to the platform to make their shared reading experience more interactive and engaging.

Alex purchases a digital copy of The History of Ancient Civilizations on the platform and uses a content sharing feature to invite his father and Sarah to join the book. The system 150 enables all three participants to read the book on their respective devices while syncing their progress, highlights, and notes. Each member can view updates and insights shared by others, fostering a shared understanding of the material.

As Alex, David, and Sarah read, the system 150 generates dynamic discussion prompts tailored to the content. For example, after reading about the rise of the Roman Empire, Alex sees a prompt asking, “How do you think the Roman Republic influenced modern democracies?” Alex responds to the prompt, and both David and Sarah are notified of his response. David replies with his thoughts, while Sarah adds a historical comparison she learned in another book. These responses are shared and saved within the system 150, creating a collaborative and personalized discussion thread.

All three participants use a highlighting tool to mark sections they find interesting or thought-provoking. For example, Alex highlights a passage about ancient engineering techniques and writes a note: “Dad, this reminds me of that documentary we watched!”, and Sarah highlights a section about trade routes and adds a comment: “Did you know some of these routes are still used today?” The system 150 notifies both Alex and David of Sarah's comment, and they reply directly within the thread, sharing their perspectives. The ability to annotate and share insights enriches their understanding of the content.

To deepen their understanding, Alex, David, and Sarah explore the interactive features of the system 150. They may review an illustrated timeline of ancient civilizations to contextualize the events discussed in the book. The system 150 may suggest additional reading materials and short videos, related to their highlighted sections, which they explore collectively. These additional materials are enabled through a search tool (e.g., an agent tool). Sarah uses a quiz feature to challenge Alex and David with questions about key events, fostering a playful yet educational group activity.

By leveraging the system 150, Alex, David, and Sarah transform their shared reading into an engaging and collaborative experience. The ability to sync progress, share insights, and participate in dynamic discussions strengthens their connection and enriches their understanding of the material. The system 150 provides a seamless way to explore content together, making the shared reading experience more meaningful and enjoyable for friends and family alike.

A seventh example scenario depicts a reading club or book club supported by the system 150. Alex and his friends form a virtual reading club to explore and discuss a historical novel. They aim to read the book together, share insights, and participate in collaborative discussions. To streamline their interactions and enhance their reading experience, the club uses the system 150 to act as a moderator. Before the club's session begins, the AI moderator reviews the book's content, structured using the AI-ready content format 900, and recommends a customized weekly reading schedule tailored to the group's preferences, availability, and time constraints.

Leveraging its capabilities and tools, the AI moderator synchronizes the suggested schedule with each member's personal agenda, ensuring alignment. For the first session, it recommends focusing on the chapters that establish the main characters and plot. Additionally, it generates an introductory overview, highlighting critical themes and historical context. The AI moderator also suggests supplementary resources, such as a timeline of historical events referenced in the book, to enrich the group's understanding.

During the reading session, the AI moderator dynamically facilitates the discussion by generating thought-provoking prompts based on the text. For example, after a key chapter exploring character motivations, the AI moderator asks, “How do you think the protagonist's decisions reflect the cultural norms of the time?” Members can respond in real-time, and the AI records their responses, identifying patterns and areas of consensus. When the group encounters a challenging or ambiguous section, a member can request clarification by saying, “What did the author mean by this metaphor?” The AI moderator provides an explanation, referencing both the book and external sources, ensuring all insights are accurately cited.

The reading club may use interactive tools to annotate the text, highlight favorite passages, and create shared notes. For example, Alex highlights a section describing the socio-political dynamics of the setting and adds a note: “This reminds me of recent discussions on global inequality.” Other members can respond to the note, fostering collaborative dialogue. The AI moderator consolidates these annotations and notes into a shared document accessible to all participants.

At the end of the session, the AI moderator generates a summary of the group's discussion, capturing key points, disagreements, and action items for the next meeting. It also recommends discussion topics for the next session based on the group's interests, such as exploring character development or analyzing the book's central themes. Additionally, the AI moderator creates a personalized quiz for each member to reinforce their understanding of the session's content and encourages members to share their reflections through short essays or audio recordings.

Using the system 150, the reading club transforms a traditional group reading experience into an engaging, interactive, and collaborative activity. The AI moderator ensures smooth discussions, provides valuable insights, and creates personalized learning opportunities for each member. By seamlessly integrating content recommendations, interactive tools, and tailored feedback, the system 150 enhances the group's engagement, making their reading journey more enriching and enjoyable.

An eighth example scenario presents a course instructor using the system 150 to control an interactive experience. Dr. Carter is a computer science professor teaching an introductory machine learning course. The university subscribes to a library of interactive textbooks through the platform, including Fundamentals of Machine Learning, which Dr. Carter assigns as the primary course text. Dr. Carter interacts with an interaction manager of the system 150 to select specific chapters, such as “Supervised Learning,” “Neural Networks,” and “Optimization Techniques.” He customizes the interactive reading experience by embedding instructions to guide his students.

Dr. Carter may mark specific book sections, such as “Gradient Descent,” as essential reading for understanding key course concepts, and/or add custom notes encouraging students to experiment with the equations presented in the textbook. The interaction manager may instruct AI agents that work with students to add the instructions of Dr. Carter to all the students of the class. The AI agents may store information as content-specific data.

Dr. Carter may use additional content to enrich the content experience of his students. Additional content may include:
Code Integration: He embeds Python snippets and links to Jupyter notebooks directly within the text, enabling students to experiment with algorithms like linear regression and neural networks;
Visual Explanations: He supplements the chapter on “Neural Networks” with interactive diagrams generated by the system 150, illustrating the flow of data through a multilayer network;
Practice Problems: Dr. Carter integrates practice questions, such as “Implement gradient descent for a simple cost function,” with immediate feedback provided by the system 150.

The additional content is stored along with the transformed and generated derivative works in the content repository 144.

The students may access the interactive textbook through the system 150. The textbook offers an engaging and dynamic experience that includes educational modules and interactive experiences. The system 150 may include embedded code snippets that allow students to directly execute algorithms and visualize outputs, fostering hands-on learning.

Dr. Carter tracks student progress and engagement through the system 150, which may generate analytics that reveal which sections students spend the most time on and their performance on quizzes and coding exercises, and/or insights that help Dr. Carter identify challenging topics, such as optimization techniques, and tailor his lectures to address these areas. The system 150 may store information about students'progress and engagement in the database 142.

The system 150 facilitates collaboration among students, enabling them to interact as group content consumers. For example, Dr. Carter establishes a study group for his class and sets up a discussion thread within the chapter on “Support Vector Machines.” Through this thread, students can post questions, share insights, and engage in discussions about the chapter's concepts. The system 150 promotes dynamic group interactions by allowing participants to highlight key points, annotate shared sections, and reply to each other's contributions in real-time.

Such interactions are managed by the system 150, which also stores the discussion thread and associated group activities as user-specific data. The data allows Dr. Carter to monitor group engagement, track individual contributions, and identify areas where students may require additional support. The stored data also enables group members to revisit past discussions, ensuring a continuous and enriching collaborative learning experience.

By leveraging aa university's subscription to the system 150, Dr. Carter transforms a static machine learning textbook into a rich, interactive learning experience. Students gain hands-on coding practice, immediate feedback on problems, and dynamic visualizations of complex algorithms. Dr. Carter, in turn, gains actionable insights into student engagement, enabling him to deliver more effective and targeted instruction.

In a ninth example scenario, the system 150 may present reading recommendations to users. Alice, a graduate student studying for her thesis on neural networks, logs into the system 150 for her daily study session. Alice relies heavily on the recommendation features of the system 150 to identify the most relevant content for her research and optimize her study time. The system 150 provides detailed, personalized pre-reading recommendations based on Alice's research focus, past interactions, and study goals

The system 150 accesses Alice's user profile, which includes her study history, preferences, and research topics, such as “Neural Network Architectures” and “Optimization Techniques.” The system 150 identifies her most recent activities, such as reading the chapter on “Gradient Descent” and engaging with interactive Q&A sessions related to “Backpropagation.”

Based on her past interactions and current focus, the system 150 recommends specific sections to read next. For example, the system 150 may recommend Chapter 5: Neural Network Architectures, and highlights subsections like “Convolutional Networks” and “Recurrent Networks” as essential for her thesis, and Chapter 7: Optimization Techniques, specifically “Regularization Methods” as a new concept she hasn't explored yet.

The system 150 generates a summary of each suggested chapter, highlighting key points such as: Definitions: “What are convolutional layers?”, Comparisons: “How do RNNs differ from CNNs?”, Practical Applications: “Where is regularization used in real-world neural networks?”, and so on. The system 150 suggests, via a search tool, additional resources to deepen Alice's understanding, such as: Articles: A blog post on “Advancements in Neural Networks,” Videos: A short tutorial on implementing regularization methods in Python, practice problems: quizzes and coding exercises related to the recommended topics, and so on.

Before Alice begins her study session, she reviews the recommendations. She decides to start with Chapter 5: Neural Network Architectures and clicks on the highlighted subsection, “Convolutional Networks.” The system 150 provides a quick overview of the section, along with a suggestion: “Would you like to explore an interactive diagram illustrating the structure of a convolutional layer?” Alice accepts, and the system 150 seamlessly integrates the diagram into her session.

As Alice progresses through the chapter, the system 150 dynamically adjusts its recommendations, as follows. If Alice spends more time on “Recurrent Networks,” the system 150 highlights additional sections related to RNNs, such as “Long Short-Term Memory Networks,’ and prompts: “Would you like a quiz to test your understanding of convolutional layers?”

After completing her study session, Alice accesses a post-reading insights feature, which reflects her activity: Topics Covered: “Convolutional Networks” and “Recurrent Networks,” Time Spent: 45 minutes, and Suggested Next Steps: “Review coding exercises on backpropagation” and “Explore advanced optimizers like Adam and RMSProp in Chapter 7.”

Thus, the system 150 ensures that Alice's study sessions are highly targeted and efficient. By focusing on the most relevant sections, supplemented with dynamic resources and interactive tools, Alice gains a deeper understanding of her research topics. The tailored guidance provided by the system 150 enhances her learning experience, saving time and improving engagement.

As a tenth example scenario, the system 150 provides a study space of multiple book interactions. John, a university student, is preparing a research paper on artificial intelligence and its applications. To support his work, John uses a Study Space feature of the system 150, which allows him to interact with multiple books simultaneously, organizing, cross-referencing, and synthesizing information seamlessly.

John adds three books to his Study Space via an interaction manager, including: Deep Learning Principles (Book 1): A foundational textbook on deep learning, Neural Networks in Practice (Book 2): A guide with real-world applications of neural networks, and AI Ethics and Implications (Book 3): A critical analysis of the ethical considerations in AI.

The system 150 organizes these books in a virtual workspace, categorizing them by topics such as “Neural Networks,” “Optimization Techniques,” and “Ethics in AI. The system 150 syncs John's reading progress across all three books, ensuring he can pick up where he left off in any section without losing context.

While reading Deep Learning Principles (Book 1), John encounters a section on “Gradient Descent.” He pauses and queries, “How is gradient descent applied in real-world scenarios?” The Study Space feature identifies a relevant section in Neural Networks in Practice (Book 2) and presents an excerpt detailing gradient descent in image recognition systems. John can compare the theoretical explanation from Book 1 with the practical example from Book 2 side by side.

John asks, “Summarize what these books say about overfitting.” The Study Space generates a combined summary from both Deep Learning Principles and Neural Networks in Practice, consolidating key points such as the causes of overfitting, regularization techniques, and case studies.

As John reads AI Ethics and Implications (Book 3), the system 150 highlights sections in the other two books that discuss related ethical considerations, such as biases in training data and the societal impact of AI models.

John highlights a passage in Deep Learning Principles about “Convolutional Neural Networks” (CNNs) and creates a note: “Important for understanding image processing.” The system 150, utilizing the note-taking tool, automatically adds the note to the virtual Study Space. The system 150 links this note to relevant sections across the other two books, enabling seamless cross-referencing.

John can create and manage notes across all three books, organizing them by topic or theme. For example, a note on “Gradient Descent” in Neural Networks in Practice is automatically associated with a theoretical explanation from Deep Learning Principles and ethical considerations from AI Ethics and Implications. These interconnections provide John with a cohesive and structured view of his study materials, enhancing his ability to synthesize information across multiple sources.

The system 150 generates quizzes to integrate concepts from all three books. Example quizzes include multiple-choice questions testing John's understanding of CNNs and gradient descent and/or open-ended questions exploring ethical implications of using CNNs in facial recognition technology.

For topics like the evolution of neural networks, the system 150 creates an interactive timeline that pulls content from all three books, helping John contextualize advancements in AI technology.

The system 150 provides a detailed overview of John's activity in the Study Space, such as time spent reading each book, key topics explored: “Gradient Descent,” “Overfitting,” and “Ethics in AI,” notes taken and sections bookmarked, and so on. Based on John's study patterns, the system 150 suggests additional resources, such as articles on ethical AI frameworks or videos explaining advanced optimization techniques.

The Study Space feature transforms John's study process into a streamlined, interactive experience. By integrating multiple books into a unified workspace, the system 150 allows John to cross-reference content, synthesize ideas, and engage deeply with his materials. This efficient and dynamic approach enhances John's productivity and understanding, making the Study Space an invaluable tool for research and learning.

Later, John adds a video series titled Neural Networks Explained to his Study Space. The system 150 categorizes the videos by topics such as “Convolutional Neural Networks,” “Gradient Descent,” and “Ethical AI Applications,” aligning them with related sections in his books. The system 150 adds the new content sources, to the virtual space. Each video is presented alongside its transcript, enabling John to reference or highlight specific parts.

While reading Deep Learning Principles (Book 1), John encounters a complex explanation of backpropagation. He clicks on a “Watch Video” link provided by the platform, which directs him to a segment in the Neural Networks Explained video series that visually demonstrates the algorithm's flow.

John highlights a key moment in the video where the instructor explains gradient descent using a real-world analogy. He adds a note: “Great example to include in my thesis.” The note-taking tool associates the note with both the video and related content in Neural Networks in Practice (Book 2).

As John watches a video on convolutional neural networks, he can pause the video to ask interactive questions, such as: “How do convolutional layers process image data?” The system 150 responds with a clear and concise answer to John's question, enhancing his understanding of the topic in real time.

After watching a video segment on “Ethical AI Applications,” John requests a summary. The system 150 generates a multimedia summary that combines key points from the video transcript, related book passages, and John's own notes, offering a cohesive overview of the topic.

The system 150 provides insights into John's interactions with video content, including total video segments watched: 3, key topics explored: “Gradient Descent,” “Backpropagation,” and “Ethical AI,” and time spent watching videos: 45 minutes.

Based on his activity, the system 150 suggests additional videos, such as “Advanced Regularization Techniques,” and relevant book chapters for further reading. Thus, the integration of video content into the Study Space enhances John's ability to understand complex concepts through visual and auditory learning. By synchronizing videos with text content, enabling interactive questions, and linking notes across media, the system 150 provides a comprehensive, multimodal learning experience. This seamless interaction allows John to explore topics in greater depth, reinforcing his understanding and making his study sessions more engaging and effective.

As an eleventh example scenario, the system 150 supports collaboration and interaction between users. Dr. Carter collaborates with Dr. Smith, a professor at a university in another country, to enhance the learning experience for both their students. Dr. Carter can collaborate with Dr. Smith to provide instructions for students who are taking Dr. Smith's class via the system 150. Dr. Carter shares the customized chapters, such as “Supervised Learning,” “Neural Networks,” and “Optimization Techniques,” with embedded instructions tailored for his students. The system 150 ensures proper licensing and usage permissions, enabling Dr. Smith to adapt the content for her class while maintaining compliance with the original licensing agreements.

Dr. Smith uses a translated version of the book and, via the system 150, modifies the content for her students. For example: Dr. Smith highlights key sections in the translated version, and adds some illustrations in her students'native language, and adds localized examples or industry-relevant case studies, enhancing the textbook's applicability to her region. The system 150 stores all modifications alongside the transformed content in the content repository 144, making the data accessible to both professors for future collaboration.

Both professors leverage the system 150 to facilitate cross-university discussions. Dr. Carter sets up a discussion thread on “Support Vector Machines,” allowing students from both universities to participate. The system 150 stores the discussion threads as part of user-specific data, enabling personalized tracking of student contributions.

Dr. Smith and Dr. Carter track their students'engagement and performance using the system 150 to determine how each group of students interacts with the shared textbook and supplemental materials. The system 150 also generates comparative performance metrics, helping the professors identify common challenges and adjust their lectures accordingly.

By leveraging the system 150, Dr. Carter and Dr. Smith collaborated in creating a globally enriched and interactive resource. Students from both universities benefit from hands-on learning experiences, collaborative discussions, and culturally relevant examples, fostering deeper understanding and global perspectives on machine learning concepts. Meanwhile, the professors gain insights into student performance and engagement, enabling targeted and effective instruction across borders.

In a twelfth example scenario, the system 150 may support publisher content transformations. Maple Leaf Publishing is a mid-sized publisher specializing in non-fiction and educational books. They are exploring ways to modernize their offerings to attract a wider audience and adapt to changing reader preferences. Their challenge lies in transforming their catalog, a collection of books published in the EPUB format, into interactive and personalized experiences without overhauling their existing workflows or compromising on copyright and rights management.

Maple Leaf Publishing uses the system 150 to seamlessly convert the books their catalog into the AI-ready content format 900. The process begins with their latest release, The Human Brain Unlocked, a non-fiction book on neuroscience. The publishing team uploads the book manuscript in EPUB format to the system 150. The system 150 automatically (via FIG. 7) enriches the manuscript with metadata, creating connections between chapters and sections while tagging key concepts such as “neuroplasticity,” “memory formation,” and “cognitive bias.”

The system 150 creates various derivative works, such as summaries and highlights of each chapter, course-style transformations, a set of interactive quizzes and exercises tailored to the book's content, a high-quality audiobook with AI-generated narration that matches the book's tone and style, diagrams and infographics for each chapter, and so on.

The publisher then uses the system 150 to enable interactive experiences for readers. For example, users can explore the book through voice interactions, asking questions like, “What is neuroplasticity?” or “Can you summarize Chapter 2?”, readers access visual timelines and illustrative figures for topics like the development of the brain, interactive educational modules make the book suitable for courses, allowing students to take quizzes or explore real-world applications, and so on.

To ensure proper attribution and monetization, Maple Leaf Publishing uses the system 150 to define licensing terms for derivative works. For example, they assign the translated version of The Human Brain Unlocked in Spanish to a distributor in Spain, ensuring regional accessibility and adherence to local licensing requirements. The system 150 allows Maple Leaf to specify usage rights, distribution platforms, and revenue-sharing agreements, allowing the distributor to market the book effectively within their region.

Maple Leaf Publishing also distributes the enriched content, enabling platforms like eBook stores and online learning platforms to integrate and offer the interactive version of The Human Brain Unlocked. These interactive versions include features such as quizzes, highlights, and illustrated content, providing an engaging and accessible experience for a diverse audience.

Using the system 150, Maple Leaf Publishing transforms a traditional non-fiction book into an engaging, multimodal experience. Readers gain access to personalized and interactive content, while the publisher reaches new audiences, such as visual learners and educators, without compromising on rights management. The result is increased engagement, higher sales, and a modernized approach to publishing.

In a thirteenth example scenario, the system 150 support content aggregation and distribution. ReadSphere, a global content aggregation and distribution company, uses the system 150 to curate and distribute diverse content from a variety of publishers. The distributed content includes books, articles, and derivative works such as audiobooks and summaries. ReadSphere aims to provide its users with personalized and engaging content experiences while ensuring proper rights management for all parties involved.

ReadSphere integrates its repository of licensed content via the system 150, which processes the content, converting it into the AI-ready content format that is enriched with metadata.

Using the system 150, ReadSphere offers personalized content recommendations to its users. For example, a business professional searching for “time management” might receive a curated bundle of a book summary, an audiobook version, and a related article. Users can also enjoy interactive and rich reading experiences, as described herein.

Further, ReadSphere uses the system 150 to ensure that all distributed content complies with licensing agreements. For example, the system 150 tracks content usage, such as audiobook plays or article downloads, automatically calculates royalties for the respective publishers, and dynamically manages the rights or access, allowing ReadSphere to adjust content offerings based on regional rights or distribution agreements.

ReadSphere uses the system 150 to integrates with popular content distribution platforms like eBook stores, audiobook platforms, and learning management systems. For example, an educational institution subscribing to ReadSphere's service can access curated educational content tailored to its curriculum, a streaming service partners with ReadSphere to offer audiobooks alongside its video content, and so on.

Thus, by leveraging the system 150, ReadSphere streamlines its content aggregation and distribution processes. The enriched, multimodal content enhances user engagement and satisfaction, while the rights management module ensures compliance and fair compensation for content creators. The result is a scalable and efficient solution that benefits both ReadSphere and its partners.

In a thirteenth example scenario, the system 150 enables a technology provider to enhance a book experience. CodexTech, a technology provider specializing in creating interactive digital experiences, partners with the system 150 to design a tailored reading experience for graphic novels. CodexTech aims to enhance the visual storytelling aspect of graphic novels while incorporating interactivity to engage readers.

CodexTech uses the system 150 to access AI-optimized version of the fantasy novel that was read by Emma above. The exported content is optimized for AI processing, allowing CodexTech to use their specialized AI agents to create some dynamic features that CodexTech envisions. Using their proprietary tools, CodexTech integrates the graphic novel content with their interactive storytelling framework.

For example, the system 150 facilitates dynamic panel navigation. CodexTech develops a feature allowing readers to zoom into individual panels dynamically, guided by the flow of the story. As the reader progresses, the system 150 highlights key transitions, mimicking the cinematic effect of animated storyboards. The system 150 may support the generation of voice-integrated characters, which are generated using proprietary AI-generated voiceovers synced to text balloons and have additional sound effects for immersive storytelling. For graphic novels with branching narratives, CodexTech introduces a proprietary choice-based interaction feature that generates a unique choose-your-own-path narrative, distinct from the one created by the platform.

CodexTech reintegrates the enhanced graphic novel experience back into the platform through the system 150. This ensures proper attribution and licensing for the original publishers while enabling seamless distribution to the platform's users.

The customized graphic novels are distributed via the system 150, and users, such as Emma, are presented with an additional content experience for the same story, allowing her to enjoy either version.

By partnering with the system 150, CodexTech expands the capabilities to support graphic novels, creating a one-of-a-kind interactive reading experience. Readers enjoy immersive storytelling features that deepen their engagement, while publishers gain a new avenue for monetizing their content. The partnership demonstrates how the platform's flexibility empowers technology providers to innovate and enhance content for unique book types.

Of course, the content experience system 150 may support other scenarios or implementations.

### Examples of the Disclosed Technology

The systems and methods may be implemented as follows.

In some examples, a system includes at least one memory and a processor coupled with the memory and configured to receive a source document having a first format, convert the source document into a multimodal object having a second format, and generate one or more multimodal content experiences using the multimodal object.

In some cases, the first format is an EPUB format and the second format is an artificial intelligence (AI)-ready content format that includes a global content descriptor for the source document and multiple chunk descriptors for multiple sections of the source document.

In some cases, to generate the one or more multimodal content experiences using the multimodal object, the processor is configured to receive a request from a user that is engaged with the source document via a user interface that presents at least a portion of the source document, generate, based on the request and using an artificial intelligence (AI) agent, a content experience associated with contents of the source document presented via the user interface, and present, within the user interface, the generated content experience.

In some cases, the request includes a request for additional information about the contents of the source document, and wherein the AI agent, in response to the request for additional information, generates a text summary, audio summary, or illustration associated with the contents of the source document as the generated content experience.

In some cases, the request includes a request to explain the contents of the source document, and wherein the AI agent, in response to the request for additional information, generates a modified version of at least a portion of the contents of the source document as the generated content experience.

In some cases, to generate the one or more multimodal content experiences using the multimodal object, the processor is configured to generate, using an artificial intelligence (AI) agent, a content experience that is a derivative of the source document.

In some cases, the content experience is a text summary, audiobook, visual timeline, interactive quiz, or learning module.

In some cases, the AI agent generates the content experience using content-specific data associated with the source content, experience-specific data associated with the content experience, navigational data associated with tracking usage of the source content, and one or more agent tools associated with tasks performed by the AI agent when generating the content experience.

In some cases, the generated content experience is a translation of the source document, and wherein the AI agent generates the translation based on translation instructions contained within the multimodal object having the second format.

In some cases, the generated content experience includes articles and blogs, summaries and highlights, translated e-books, audiobooks and narrated stories, podcasts, course-style content, illustrated content, quizzes and workbooks, or choose-your-own-path narratives.

In some cases, the source document is a text-based document.

In some cases, the source document is an audio file, a video file, or a piece of multimedia content.

In some examples, a method includes receiving a source document having a first format, converting the source document into a multimodal object having a second format, and generating one or more multimodal content experiences using the multimodal object.

In some cases, the first format is an EPUB format and the second format is an artificial intelligence (AI)-ready content format that includes a global content descriptor for the source document and multiple chunk descriptors for multiple sections of the source document.

In some cases, generating the one or more multimodal content experiences using the multimodal object includes receiving a request from a user that is engaged with the source document via a user interface that presents at least a portion of the source document, generating, based on the request and using an artificial intelligence (AI) agent, a content experience associated with contents of the source document presented via the user interface, and presenting, within the user interface, the generated content experience.

In some cases, generating the one or more multimodal content experiences using the multimodal object includes generating, using an artificial intelligence (AI) agent, a content experience that is a derivative of the source document.

In some cases, the generated content experience is a translation of the source document, and wherein the AI agent generates the translation based on translation instructions contained within the multimodal object having the second format.

In some examples, a non-transitory, computer-readable medium whose contents, when executed by a content experience system, causes the content experience system to perform a method, the method comprising receiving a text-based source document having a first format, converting the source document into a multimodal object having a second format, wherein the second format includes: document-level metadata, chunk-level metadata, and fragment-level metadata, and generating one or more multimodal content experiences using the multimodal object.

In some cases, the first format is an EPUB format and the second format is an artificial intelligence (AI)-ready content format.

In some cases, generating the one or more multimodal content experiences using the multimodal object further comprises generating an initial version of a content experience using a first artificial intelligence (AI) agent, validating the initial version of the content experience using a second AI agent, packaging the validated content experience using a third AI agent, and presenting the packaged content experience via a user interface associated with a user of the content experience system.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of examples of the disclosure is not intended to be exhaustive or to limit the teachings to the precise form disclosed above. While specific examples of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

From the foregoing, it will be appreciated that specific examples have been described herein for purposes of illustration, but that various modifications may be made without deviating from the spirit and scope of the examples. Accordingly, the examples are not limited except as by the appended claims.

What is claimed is:

1. A system, comprising:
at least one memory; and
a processor coupled with the memory and configured to:
receive a source document having a first format;
convert the source document into a multimodal object having a second format; and
generate one or more multimodal content experiences using the multimodal object.

2. The system of claim 1, wherein the first format is an EPUB format and the second format is an artificial intelligence (AI)-ready content format that includes a global content descriptor for the source document and multiple chunk descriptors for multiple sections of the source document.

3. The system of claim 1, wherein, to generate the one or more multimodal content experiences using the multimodal object, the processor is configured to:
receive a request from a user that is engaged with the source document via a user interface that presents at least a portion of the source document;
generate, based on the request and using an artificial intelligence (AI) agent, a content experience associated with contents of the source document presented via the user interface; and
present, within the user interface, the generated content experience.

4. The system of claim 3, wherein the request includes a request for additional information about the contents of the source document, and
wherein the AI agent, in response to the request for additional information, generates a text summary, audio summary, or illustration associated with the contents of the source document as the generated content experience.

5. The system of claim 3, wherein the request includes a request to explain the contents of the source document, and
wherein the AI agent, in response to the request for additional information, generates a modified version of at least a portion of the contents of the source document as the generated content experience.

6. The system of claim 1, wherein, to generate the one or more multimodal content experiences using the multimodal object, the processor is configured to:
generate, using an artificial intelligence (AI) agent, a content experience that is a derivative of the source document.

7. The system of claim 6, wherein the content experience is a text summary, audiobook, visual timeline, interactive quiz, or learning module.

8. The system of claim 6, wherein the AI agent generates the content experience using:
content-specific data associated with the source content,
experience-specific data associated with the content experience,
navigational data associated with tracking usage of the source content, and
one or more agent tools associated with tasks performed by the AI agent when generating the content experience.

9. The system of claim 6, wherein the generated content experience is a translation of the source document, and wherein the AI agent generates the translation based on translation instructions contained within the multimodal object having the second format.

10. The system of claim 1, wherein the generated content experience includes articles and blogs, summaries and highlights, translated e-books, audiobooks and narrated stories, podcasts, course-style content, illustrated content, quizzes and workbooks, or choose-your-own-path narratives.

11. The system of claim 1, wherein the source document is a text-based document.

12. The system of claim 1, wherein the source document is an audio file, a video file, or a piece of multimedia content.

13. A method, comprising:
receiving a source document having a first format;
converting the source document into a multimodal object having a second format; and
generating one or more multimodal content experiences using the multimodal object.

14. The method of claim 13, wherein the first format is an EPUB format and the second format is an artificial intelligence (AI)-ready content format that includes a global content descriptor for the source document and multiple chunk descriptors for multiple sections of the source document.

15. The method of claim 13, wherein generating the one or more multimodal content experiences using the multimodal object includes:
receiving a request from a user that is engaged with the source document via a user interface that presents at least a portion of the source document;
generating, based on the request and using an artificial intelligence (AI) agent, a content experience associated with contents of the source document presented via the user interface; and
presenting, within the user interface, the generated content experience.

16. The method of claim 13, wherein generating the one or more multimodal content experiences using the multimodal object includes:
generating, using an artificial intelligence (AI) agent, a content experience that is a derivative of the source document.

17. The method of claim 16, wherein the generated content experience is a translation of the source document, and wherein the AI agent generates the translation based on translation instructions contained within the multimodal object having the second format.

18. A non-transitory, computer-readable medium whose contents, when executed by a content experience system, causes the content experience system to perform a method, the method comprising:
receiving a text-based source document having a first format;
converting the source document into a multimodal object having a second format,
wherein the second format includes:
document-level metadata,
chunk-level metadata, and
fragment-level metadata; and
generating one or more multimodal content experiences using the multimodal object.

19. The non-transitory, computer-readable medium of claim 18, wherein the first format is an EPUB format and the second format is an artificial intelligence (AI)-ready content format.

20. The non-transitory, computer-readable medium of claim 18, wherein generating the one or more multimodal content experiences using the multimodal object further comprises:
generating an initial version of a content experience using a first artificial intelligence (AI) agent;
validating the initial version of the content experience using a second AI agent;
packaging the validated content experience using a third AI agent; and
presenting the packaged content experience via a user interface associated with a user of the content experience system.
